(19) United States
(12) Patent Application Publication
(10) Pub. No.: US 2026/0252808 A1
(43) Pub. Date: Aug. 27, 2026

(54) SYSTEM

(71) Applicant: SoftBank Group Corp., Tokyo (JP)

(72) Inventor: Jotaro KOIKE, Tokyo (JP)

(73) Assignee: SoftBank Group Corp., Tokyo (JP)

(21) Appl. No.: 19/538,983

(22) Filed: Feb. 13, 2026

(30) Foreign Application Priority Data
Feb. 21, 2025 (JP) 2025-027075

(51) Int. Cl. G06F 40/30

(52) U.S. Cl. CPC G06F 40/30

(57) ABSTRACT

The system according to the embodiment includes a reception unit, an analysis unit, an evaluation unit, and an arrangement unit. The reception unit receives a symptom input from a user. The analysis unit analyzes symptom data received by the reception unit. The evaluation unit evaluates a degree of urgency based on data analyzed by the analysis unit. The arrangement unit arranges an ambulance based on the degree of urgency evaluated by the evaluation unit.

### CROSS-REFERENCE TO RELATED APPLICATION

The present application claims priority to and incorporates by reference the entire contents of Japanese Patent Application No. 2025-027075 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to quickly determine an appropriate response when a child has a high fever or becomes unwell late at night.

### SUMMARY OF THE INVENTION

The system according to the embodiment includes a reception unit, an analysis unit, an evaluation unit, and an arrangement unit. The reception unit receives a symptom input from a user. The analysis unit analyzes symptom data received by the reception unit. The evaluation unit evaluates a degree of urgency based on data analyzed by the analysis unit. The arrangement unit arranges an ambulance based on the degree of urgency evaluated by the evaluation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

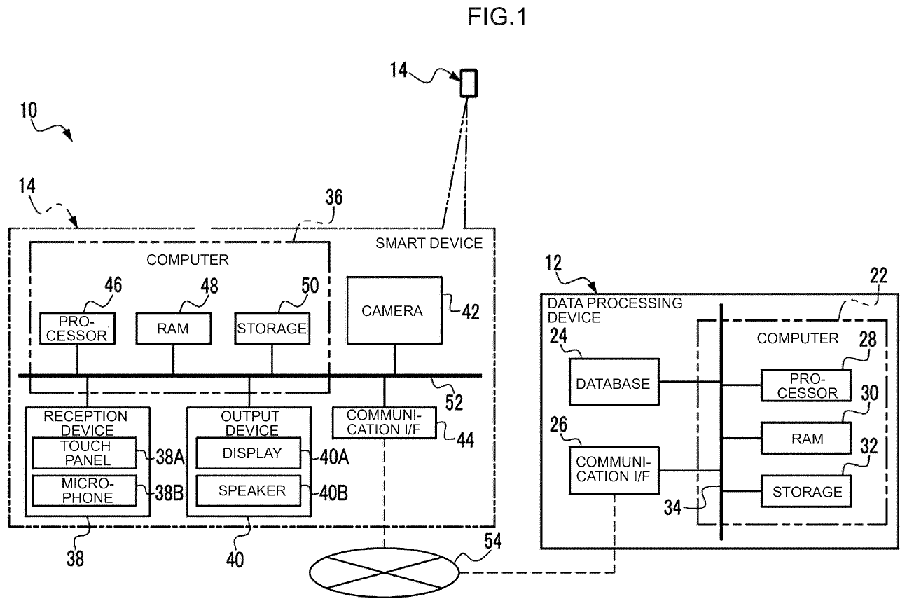

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

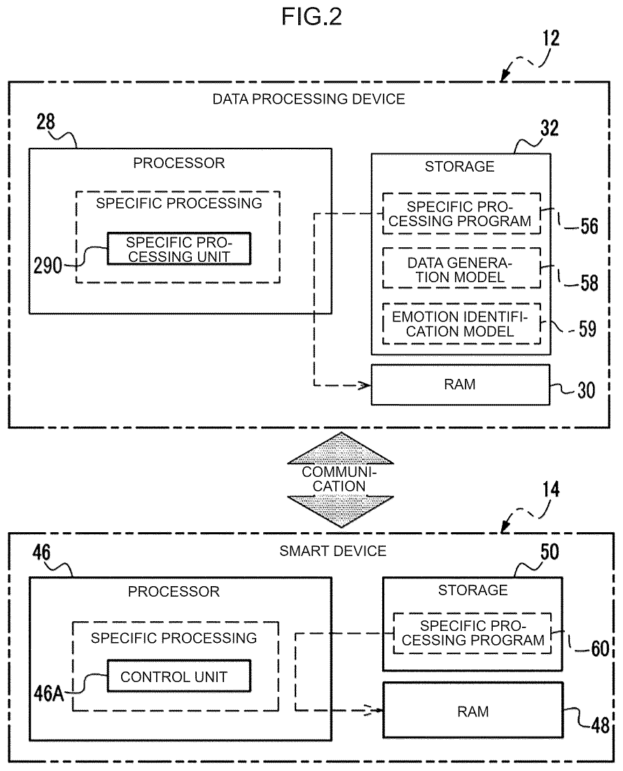

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system in which, when a child develops a high fever, becomes unwell, or gets injured late at night, instead of immediately using a night clinic or an ambulance, a user inputs symptoms using generative AI and transmits image or video data if necessary, whereby the AI determines the symptoms and arranges an ambulance as necessary. This system starts with the user inputting the child's symptoms into the generative AI. For example, symptoms such as “the child has a high fever” or “the child got injured” are input. At this time, image or video data can also be transmitted as necessary. For example, an image of the child's rash or a video filming the state of the injury is transmitted. Next, the generative AI analyzes the input symptom data and determines the child's symptoms. The generative AI evaluates a degree of urgency of the symptoms based on pre-registered information on a child or an address. For example, if the high fever continues or the degree of injury is serious, the generative AI arranges an ambulance on the spot. Furthermore, even if the symptom is not urgent, the generative AI provides an appropriate coping method to the user. For example, it advises on a method to lower the child's body temperature or a method of first aid for the injury. In this way, the user can take appropriate measures even late at night. With this system, even if a child's symptoms occur late at night, appropriate measures can be taken immediately, and an ambulance can be arranged quickly if necessary. In addition, by registering the information on the child and the address in advance, the generative AI can make a quick determination. Thereby, the system can respond quickly and appropriately even if the child develops a high fever, becomes unwell, or gets injured late at night. Specifically, the present system is driven by a composite neural network including a large-scale language model and an image recognition model built on a cloud computing environment or an edge computing environment. The generative AI in the present system adopts a deep learning model based on a Transformer architecture, and executes semantic analysis by tokenizing natural language text (e.g., a word string such as “high fever”) input from the user and embedding it into a high-dimensional vector space. When image or video data is transmitted, the present system extracts image feature amounts using a Convolutional Neural Network (CNN) or a Vision Transformer (ViT), and performs multimodal learning processing to integrate them with text feature amounts. Input data to the AI includes, for example, an RGB image tensor with a resolution of 512×512 pixels, audio waveform data with a sampling rate of 44.1 kHz, and a text token sequence. Output data from the AI includes a probability score (range of 0.0 to 1.0) corresponding to each symptom category (fever, trauma, poisoning, etc.), a class label indicating an urgency level (levels 1 to 5), and generated text data including a recommended coping method. As subsequent processing, the present system determines whether or not the output urgency score exceeds a predetermined threshold (e.g., 0.85), and if it exceeds, automatically calls an API (Application Programming Interface) of an emergency command center and transmits an ambulance dispatch request together with GPS location information. On the other hand, if it is less than the threshold, the system searches for relevant information from a highly reliable medical database using Retrieval-Augmented Generation (RAG) technology, and inputs the information as context into the language model, thereby generating a specific coping method based on medical evidence in natural language and displaying it on a user terminal. Thus, the present system achieves a technical effect distinct from conventional technology in that it is not a mere rule-based automatic response but understands subtle nuances of context and images through vector arithmetic in a high-dimensional feature space to make dynamic determinations.

The system according to the embodiment comprises a reception unit, an analysis unit, an evaluation unit, and an arrangement unit. The reception unit receives a symptom input from a user. The symptom input from the user includes, for example, text input, voice input, image input, etc., but is not limited to such examples. The reception unit receives, for example, that the user inputs “the child has a high fever” in text. Also, the reception unit can receive that the user explains symptoms by voice. Furthermore, the reception unit can receive that the user transmits image or video data. For example, it receives that the user transmits an image of the child's rash or transmits a video filming the state of an injury. The analysis unit analyzes symptom data received by the reception unit using generative AI. The analysis is performed based on, for example, an algorithm to be used or accuracy of analysis, but is not limited to such examples. For example, the generative AI analyzes text data input by the user using text generative AI (e.g., LLM). Also, the generative AI can analyze image data transmitted by the user using image generative AI. Furthermore, the generative AI can analyze video data transmitted by the user using multimodal generative AI. The evaluation unit evaluates a degree of urgency based on data analyzed by the analysis unit. The evaluation of the degree of urgency is performed based on, for example, severity of symptoms or temporal factors, but is not limited to such examples. For example, the evaluation unit evaluates that the degree of urgency is high when high fever continues or when the degree of injury is serious. Also, the evaluation unit can evaluate that the degree of urgency is low when the symptom is mild. The arrangement unit arranges an ambulance based on the degree of urgency evaluated by the evaluation unit. The arrangement is performed based on, for example, priority of arrangement or means of arrangement, but is not limited to such examples. For example, the arrangement unit quickly arranges an ambulance when the degree of urgency is high. Also, the arrangement unit can provide an appropriate coping method to the user when the degree of urgency is low. Thereby, the system according to the embodiment automates the process from the user's symptom input to the arrangement of the ambulance, and can respond quickly. Specifically, the reception unit is an interface module that receives data via an HTTP request or WebSocket communication from a client terminal such as a smartphone or a smart speaker, classifies the received multimodal data by type, performs pre-processing (noise removal, normalization, etc.), and transfers it to the analysis unit. The analysis unit is an inference engine operating on a GPU (Graphics Processing Unit) cluster, and uses a Transformer model such as BERT or GPT for text data, and uses a CNN model such as ResNet or EfficientNet for image data. Particularly in the case of multimodal generative AI, the analysis unit combines outputs from a text encoder and an image encoder by a Cross-Attention mechanism, and analyzes a correlation between visual features in the image and linguistic descriptions. Input to the AI is, for example, a text embedding vector (dimension number 768 or 1024) and an image feature map (dimension number 2048). Output from the AI is a numerical score indicating severity of the symptom (e.g., continuous value of 0 to 100) or a probability distribution corresponding to a specific medical condition (e.g., “febrile seizure”, “arterial bleeding”). Based on this probability distribution, the evaluation unit determines a final urgency class (e.g., immediate transport, visit on the same day, follow-up observation) using a classifier such as logistic regression or a decision tree. The arrangement unit is triggered when the evaluation unit determines “immediate transport”, performs API coordination with an external emergency control system, and transmits data in JSON format including the user's current location (latitude and longitude information) and a symptom summary. Since this series of processing is completed within a few seconds without human intervention, there is a remarkable technical effect of minimizing time lag in an emergency and contributing to improvement of a survival rate.

The system comprises a management unit configured to manage pre-registered information. The management unit manages the pre-registered information. The pre-registered information includes, for example, a child's name, age, address, health condition, etc., but is not limited to such examples. The management unit receives, for example, that the user registers the child's name and age. Also, the management unit can receive that the user registers the child's address and health condition. Furthermore, the management unit can receive an update of the pre-registered information. For example, it receives that the user registers a change in the child's health condition or registers a change of address. Thereby, the management unit enables a quick response by managing the pre-registered information. Specifically, the management unit is configured using a relational database (RDB) or a NoSQL database, and securely stores structured data using a user ID as a primary key. The pre-registered information is not only saved as mere text data, but some information (e.g., medical history and allergy information) is vectorized (Embedding) by a natural language processing model and stored in a vector database. This enables the analysis unit to perform a similarity search (cosine similarity calculation, etc.) between a current symptom vector and a past medical history vector at high speed when analyzing symptoms. As input to the AI, the management unit supplies attribute data (numerical value of age, categorical value of gender, text embedding vector of medical history) associated with the user ID to the analysis unit. Output from the AI is a risk score corrected by taking this attribute information into account. For example, even for the same input of “fever”, if the age is “under 3 months”, the AI performs weighting processing so as to calculate a high risk score. As subsequent processing, when there is an update of information by the user, the management unit immediately performs re-indexing processing and reflects the latest vector data in inference. Thus, the configuration that integrates static attribute information into a dynamic inference process in real time enables high-precision determination optimized for each individual user.

The system comprises a providing unit configured to provide a coping method corresponding to a symptom. The providing unit provides the coping method corresponding to the symptom. The coping method includes, for example, a procedure for first aid, guidance on medical institutions, etc., but is not limited to such examples. For example, when the user complains of the child's high fever, the providing unit provides a method to lower the body temperature. Also, when the user complains of the child's injury, the providing unit can provide a method of first aid for the injury. Furthermore, the providing unit can provide guidance on appropriate medical institutions according to the child's symptoms. For example, the providing unit provides information on nearby hospitals or clinics. Thereby, the providing unit enables the user to take appropriate measures by providing the coping method corresponding to the symptom. Specifically, the providing unit adopts a RAG (Retrieval-Augmented Generation) architecture combining a natural language generation module using a Large Language Model (LLM) and a search module that searches a medical knowledge base. The providing unit takes the symptom category (e.g., “burn”) identified by the analysis unit and the urgency level as input, and searches for relevant document chunks from a reliable medical guideline database. Next, the searched documents and the user's situation (child's age, etc.) are input to the LLM as a prompt. Input to the AI is a symptom context, searched knowledge text, and a generation instruction prompt. Output from the AI is a specific coping procedure (step-by-step text) to be displayed to the user and a list of recommended medical institutions. As subsequent processing, the providing unit performs fact-check filtering to suppress hallucination (generation not based on facts) on the generated text, and renders only information whose safety has been confirmed on a display of the user terminal. In addition, regarding the guidance on medical institutions, the providing unit collates the user's GPS location information with a vacancy status database (real-time API) of medical institutions, and outputs a facility that is currently available for medical treatment and is at the shortest distance in a map application linkage format. This mechanism makes it possible to immediately present an actionable plan tailored to an individual situation, which cannot be obtained with a general-purpose search engine.

The system comprises a processing unit configured to process image or video data. The processing unit processes the image or video data. The image or video data includes, for example, an image of a child's rash, a video filming a state of an injury, etc., but is not limited to such examples. For example, the processing unit analyzes the image of the child's rash transmitted by the user. Also, the processing unit can analyze the video filming the state of the injury transmitted by the user. Furthermore, the processing unit can adjust resolution or format of the image or video data. For example, the processing unit performs more detailed analysis by increasing the resolution of the image. Also, the processing unit can improve accuracy of analysis by converting the format of the video. Thereby, the processing unit enables more accurate determination of symptoms by processing the image or video data. Specifically, the processing unit first executes normalization (scaling pixel values to a range of 0 to 1), resizing, and noise removal filtering as pre-processing on the input image data. When a low-resolution image is input, the processing unit restores and sharpens details of the image (shape of rash, depth of wound, etc.) using a Super-Resolution GAN (Generative Adversarial Networks) model. In the case of video data, the processing unit extracts key frames from a group of time-series frames, and extracts spatiotemporal feature amounts using a 3D-CNN or a Video Transformer. Input to the AI is a pre-processed image tensor (e.g., [batch size, number of channels, height, width]) or a tensor of a video clip. Output from the AI is bounding box coordinates indicating a Region of Interest (ROI) in the image, a segmentation mask (identification of an affected area in pixel units), and a lesion probability of each region. As subsequent processing, the processing unit quantifies feature amounts (color, size, shape) of the identified affected area and passes them to the analysis unit, thereby supporting visual severity determination that cannot be distinguished only by text information. This image processing pipeline enables stable and high-precision image diagnosis support without depending on the user's shooting environment or device performance.

The reception unit is configured to also receive image or video data as necessary when receiving the symptom input from the user. The reception unit also receives image or video data as necessary when receiving the symptom input from the user. “As necessary” is determined based on, for example, a type of symptom or a request from the user, but is not limited to such examples. For example, the reception unit receives that the user transmits an image of a child's rash. Also, the reception unit can receive that the user transmits a video filming a state of an injury. Furthermore, the reception unit can receive that the user transmits voice data explaining the symptom. Thereby, the reception unit enables more accurate determination of symptoms by also receiving image or video data. Specifically, the reception unit has control logic that analyzes contents of initial text input (dialogue with a chatbot, etc.) in real time, and dynamically deploys a UI component for image upload on the user terminal when a specific keyword (e.g., “red”, “swollen”, “bleeding”) is detected. When voice data is input, the reception unit converts an audio waveform into text using an Automatic Speech Recognition (ASR) model, and simultaneously extracts paralinguistic information (tone of voice, breathing sound, crying voice). Input to the AI is a spectrogram image of voice or MFCC (Mel-Frequency Cepstral Coefficients) feature amounts. Output from the AI is a text string and an urgency score estimated from the voice. As subsequent processing, the reception unit organizes multimodal information obtained from text, image, and voice in order of timestamps, and transmits it as an integrated context object to the analysis unit. Thus, the configuration that dynamically expands input modalities makes it possible to collect information necessary for diagnosis without omission while minimizing the user's effort.

The evaluation unit is configured to evaluate the degree of urgency of the symptom based on pre-registered information on a child or an address. The evaluation unit evaluates the degree of urgency of the symptom based on the pre-registered information on the child or the address. The pre-registered information includes, for example, the child's name, age, health condition, address, etc., but is not limited to such examples. For example, the evaluation unit evaluates that the degree of urgency is high when high fever continues in consideration of the child's age and health condition. Also, the evaluation unit can evaluate that the degree of urgency is high when the degree of injury is serious in consideration of a situation of nearby medical institutions based on the child's address. Thereby, the evaluation unit enables a quick and accurate response by evaluating the degree of urgency based on the pre-registered information. Specifically, the evaluation unit executes an algorithm that determines a final degree of urgency by multiplying or adding a “correction coefficient” based on the pre-registered information to a “basic urgency score” calculated from the input symptom data. For example, the lower the age (e.g., newborn), or if there is a specific underlying disease (asthma, heart disease, etc.), the higher the correction coefficient is set. Input to the AI is an integrated vector obtained by concatenating a feature vector of the symptom and an embedding vector of user attributes. An AI model (e.g., a gradient boosting decision tree or a multilayer perceptron) takes this integrated vector as input and outputs a probability distribution of urgency classes (e.g., levels 1 to 5). Furthermore, the address information is used as a geospatial index, and the evaluation unit coordinates with an external traffic status API or hospital availability status API to calculate an estimated time required for transport. As subsequent processing, if it is determined that the symptom is serious and access to a nearby hospital is difficult (traffic congestion or full occupancy), the evaluation unit further raises the degree of urgency and outputs a signal suggesting necessity of a doctor helicopter or wide-area transport to the arrangement unit. This evaluation logic based on multivariate analysis has an effect of significantly reducing a risk of misjudgment compared to a case depending only on single symptom information.

The reception unit is configured to estimate an emotion of the user and adjust an interface for the symptom input based on the estimated emotion of the user. The reception unit estimates the emotion of the user and adjusts the interface for the symptom input based on the estimated emotion of the user. The estimation of emotion is performed using, for example, technology such as facial expression recognition or voice analysis, but is not limited to such examples. For example, when the user is in a hurry, the reception unit provides a simple and intuitive interface so that the symptom can be input quickly. Also, when the user is calm, the reception unit can provide detailed input options so that more specific symptoms can be input. Furthermore, when the user feels anxious, the reception unit can display a design or message that gives a sense of security to support input work. Thereby, the reception unit enables more appropriate symptom input by adjusting the interface according to the user's emotion. The estimation of emotion is realized using an emotion estimation function using, for example, an emotion engine or generative AI. The generative AI is text generative AI (e.g., LLM), multimodal generative AI, or the like, but is not limited to such examples. Specifically, the reception unit monitors raw data from a camera image or microphone audio of the user terminal, or behavioral data such as typing speed or erroneous input rate of input text in real time, and inputs it to an emotion recognition AI model. Input to the AI is facial expression feature points (landmarks) of a face image, time-series data of pitch and intensity of voice, and an emotion polarity value of text. Output from the AI is coordinates (arousal, valence) on an emotion space based on Russell's circumplex model or the like, or a probability distribution of basic emotion categories (impatience, fear, calmness, etc.). As subsequent processing, the reception unit controls a UI rendering engine based on this emotion estimation result. For example, when an “impatience” score is high, the reception unit switches to an “emergency mode” in which button sizes on a screen are enlarged and input items are narrowed down to only essential “symptoms” and “photos”. On the other hand, when a “calmness” score is high, the reception unit selects a “detailed mode” that expands a detailed medical questionnaire form. This adaptive UI control achieves a remarkable improvement in Human-Computer Interaction (HCl) that allows even a user in a panic state to input necessary information quickly without erroneous operation.

The reception unit is configured to analyze a past symptom input history of the user and propose an optimal input method. The reception unit analyzes the past symptom input history of the user and proposes the optimal input method. The past symptom input history includes, for example, symptoms input by the user in the past, an input method used, etc., but is not limited to such examples. For example, based on symptoms input by the user in the past, the reception unit automatically displays frequently input symptoms as candidates. Also, the reception unit can preferentially propose an input method (voice, text, etc.) used by the user in the past. Furthermore, the reception unit can predict and propose a symptom input in a specific time zone from the past symptom input history of the user. Thereby, the reception unit can propose the optimal input method to the user by analyzing the past symptom input history. Specifically, the reception unit learns and infers input log data for each user using a Recurrent Neural Network (RNN), Long Short-Term Memory (LSTM), or a Transformer-based time-series prediction model. Input to the AI is sequence data of past input timestamps, symptom category IDs, used devices, and input modalities (voice/text). Output from the AI is a predicted probability of a symptom category that is highly likely to occur next, and a recommendation score of an input modality preferred by the user. As subsequent processing, the reception unit dynamically generates an initial screen (dashboard) immediately after application activation based on this prediction result. For example, for a user who frequently inputs “asthma attack” in the past, an “asthma” button is placed at the top to provide a shortcut that allows input completion with one tap. Also, if there is a tendency to use voice input frequently at night, the microphone is automatically set to a standby state during night hours. This personalization function significantly reduces cognitive load and operation time required for input, and improves usability in an emergency.

The reception unit is configured to customize an input method based on a current environment of the user at a time of the symptom input. The reception unit customizes the input method based on the current environment of the user (e.g., time zone or location) at the time of the symptom input. The current environment includes, for example, the user's location information, surrounding conditions, etc., but is not limited to such examples. For example, late at night, the reception unit provides a concise and quick input method so that the user can input symptoms quickly. Also, when the user is at home, the reception unit can provide detailed input options so that more specific symptoms can be input. Furthermore, when the user is out, the reception unit can prioritize voice input so that symptoms can be input quickly. Thereby, the reception unit enables quick and appropriate symptom input by customizing the input method according to the user's current environment. Specifically, the reception unit collects raw data from various sensors (GPS, illuminance sensor, acceleration sensor, microphone) mounted on the user terminal, and classifies a current environmental state by a context recognition algorithm. Input to the AI is an environmental parameter vector such as current time, GPS coordinates, surrounding noise level (dB), and illuminance (lux). Output from the AI is an environmental context label (e.g., “home/quiet”, “outdoors/moving”, “midnight/dark place”). As subsequent processing, the reception unit branches a UI/UX flow according to this label. For example, when it is determined as “outdoors/moving”, a high contrast mode that enhances visibility is applied, and voice input or selection input using large buttons is made default rather than keyboard input. Also, in the case of “midnight/dark place”, brightness of the screen is adjusted and a dark mode is applied to suppress stimulation to the user's eyes. Thus, optimizing the input method in consideration of physical environmental factors has a technical effect of guaranteeing reliable data input in any situation.

The reception unit is configured to estimate an emotion of the user and determine a priority of the symptom input based on the estimated emotion of the user. The reception unit estimates the emotion of the user and determines the priority of the symptom input based on the estimated emotion of the user. The estimation of emotion is performed using, for example, technology such as facial expression recognition or voice analysis, but is not limited to such examples. For example, when the user is in a hurry, the reception unit enables symptoms with a high degree of urgency to be input preferentially. Also, when the user is calm, the reception unit can enable detailed symptoms to be input in order. Furthermore, when the user feels anxious, the reception unit can display a message giving a sense of security and enable important symptoms to be input. Thereby, the reception unit enables more appropriate symptom input by determining the priority of the symptom input according to the user's emotion. The estimation of emotion is realized using an emotion estimation function using, for example, an emotion engine or generative AI. The generative AI is text generative AI (e.g., LLM), multimodal generative AI, or the like, but is not limited to such examples. Specifically, the reception unit performs slot filling control that dynamically rearranges a presentation order of question items (slots) of a medical questionnaire based on an “Urgency” score output by an emotion estimation model. Input to the AI is multimodal data such as the user's voice tone, facial expression, and input speed. Output from the AI is an urgency score normalized in a range of 0.0 to 1.0. As subsequent processing, when the urgency score exceeds a threshold (e.g., 0.8), the reception unit displays confirmation items of vital signs related to life such as “Is there consciousness?” and “Is the patient breathing?” with top priority, and postpones or skips detailed situation explanation and input of medical history. Conversely, when the score is low, it prompts input of detailed symptom progress along a time series. This dynamic prioritization enables the system side to actively select information under a situation with a high degree of urgency, and secure minimum information necessary for lifesaving in the shortest time.

The reception unit is configured to preferentially input a highly relevant symptom in consideration of geographical location information of the user at a time of the symptom input. The reception unit preferentially inputs a highly relevant symptom in consideration of the geographical location information of the user at the time of the symptom input. The geographical location information includes, for example, GPS data, a location information service, etc., but is not limited to such examples. For example, when the user is in a specific region, the reception unit enables a disease or symptom prevalent in that region to be input preferentially. Also, when the user is traveling, the reception unit can enable a symptom related to a health risk at a travel destination to be input preferentially. Furthermore, when the user is at home, the reception unit can enable a highly relevant symptom to be input preferentially based on a past symptom history. Thereby, the reception unit can preferentially input a highly relevant symptom by considering the user's geographical location information. Specifically, the reception unit transmits a query in real time to a “regional infectious disease epidemic database” provided by a public health organization or an infectious disease surveillance system, using the user's GPS coordinates as a key. Input to the AI is the user's location information (latitude/longitude) and current season/weather data. Output from the AI is a disease list (e.g., influenza, dengue fever, food poisoning, etc.) with a high probability of occurrence in that region/period and related symptom keywords. As subsequent processing, the reception unit displays these high-probability symptoms at the top in an autocomplete function of an input form or a list of choices. For example, when food poisoning is prevalent in a specific tourist spot, symptom buttons such as “abdominal pain” and “vomiting” are placed in conspicuous positions. This context-aware input support based on location information allows the user to quickly find an item matching their own symptom, improving input efficiency and data accuracy.

The reception unit is configured to analyze a social media activity of the user and input a relevant symptom at a time of the symptom input. The reception unit analyzes the social media activity of the user and inputs the relevant symptom at the time of the symptom input. The social media activity includes, for example, health information shared by the user on social media, information on health-related accounts followed by the user, etc., but is not limited to such examples. For example, based on health information shared by the user on social media, the reception unit automatically inputs a relevant symptom. Also, based on information on health-related accounts followed by the user on social media, the reception unit can propose a relevant symptom. Furthermore, based on information on a health-related group in which the user participates on social media, the reception unit can input a relevant symptom. Thereby, the reception unit can automatically input a relevant symptom by analyzing the user's social media activity. Specifically, the reception unit acquires data of recent post texts and “liked” articles via an API from a social media account (SNS) linked based on the user's consent, and analyzes it using Natural Language Processing (NLP). Input to the AI is post text data and activity logs of the SNS. Output from the AI is extracted health-related keywords (e.g., “headache”, “can't sleep”, “feeling like catching a cold”) and a user's interest topic vector. As subsequent processing, the reception unit presets these keywords as initial values of a symptom input form, or displays a confirmation message such as “You recently posted about a headache, is it that symptom?”. This function enables the system to actively pick up a potential health issue that the user is not aware of or has forgotten to input, and utilize it as auxiliary information for improving accuracy of diagnosis.

The analysis unit is configured to estimate an emotion of the user and adjust accuracy of analysis based on the estimated emotion of the user. The analysis unit estimates the emotion of the user and adjusts the accuracy of analysis based on the estimated emotion of the user. The estimation of emotion is performed using, for example, technology such as facial expression recognition or voice analysis, but is not limited to such examples. For example, when the user is in a hurry, the analysis unit performs analysis quickly and preferentially analyzes a symptom with a high degree of urgency. Also, when the user is calm, the analysis unit can perform detailed analysis and provide a more accurate result. Furthermore, when the user feels anxious, the analysis unit can perform analysis while displaying a message giving a sense of security. Thereby, the analysis unit can provide a more accurate analysis result by adjusting the accuracy of analysis according to the user's emotion. The estimation of emotion is realized using an emotion estimation function using, for example, an emotion engine or generative AI. The generative AI is text generative AI (e.g., LLM), multimodal generative AI, or the like, but is not limited to such examples. Specifically, the analysis unit includes a model routing function that dynamically switches a size of an inference model to be used or computing resources according to an emotion estimation result. Input to the AI is a user's emotion label (e.g., “impatience”, “calmness”). Output from the AI is a model selection signal and inference parameters (beam search width, sampling temperature, etc.). As subsequent processing, when the user is in an “impatience” state, the analysis unit selects a lightweight model with low calculation cost (distilled model, etc.) to minimize latency and immediately output a rough estimate result (triage level). On the other hand, when the user is “calm”, the analysis unit uses a large-scale model with a large number of parameters or an ensemble learning model to perform high-precision differential diagnosis even if it takes calculation time. This trade-off control makes it possible to provide optimal performance matching the user's psychological state and urgency.

The analysis unit is configured to adjust a level of detail of analysis based on importance of the symptom at a time of analysis. The analysis unit adjusts the level of detail of analysis based on the importance of the symptom at the time of analysis. The adjustment of the level of detail is performed based on, for example, depth of analysis or granularity of data, but is not limited to such examples. For example, the analysis unit performs detailed analysis for a symptom with a high degree of urgency such as high fever or severe injury. Also, the analysis unit can perform simple analysis for a mild symptom and provide a result quickly. Furthermore, the analysis unit can adjust priority of analysis according to the importance of the symptom and perform analysis efficiently. Thereby, the analysis unit enables efficient analysis by adjusting the level of detail of analysis according to the importance of the symptom. Specifically, the analysis unit adopts a multi-stage configuration (cascade processing) consisting of a first-stage lightweight model that performs initial screening and a second-stage high-precision model that performs detailed analysis. Input to the AI is initially input symptom text or vital data. Output from the AI is a provisional importance score by the first-stage model. As subsequent processing, if this importance score exceeds a predetermined value, the system activates a second-stage detailed analysis process. In the detailed analysis, processing with high calculation load such as pixel-level segmentation of image data, frequency analysis of time-series data, and further cross-reference with an external medical database is executed. Conversely, if the importance is low, only the result of the first stage is returned to reduce server load. This adaptive processing flow has a technical effect of concentrating limited computing resources on severe cases and maximizing efficiency and responsiveness of the entire system.

The analysis unit is configured to apply a different analysis algorithm in accordance with a category of the symptom at a time of analysis. The analysis unit applies a different analysis algorithm in accordance with the category of the symptom at the time of analysis. The analysis algorithm includes, for example, a machine learning algorithm, a statistical analysis method, etc., but is not limited to such examples. For example, the analysis unit applies an appropriate analysis algorithm to symptoms of different categories such as fever and injury. Also, the analysis unit can select an optimal analysis method according to the category of the symptom and improve analysis accuracy. Furthermore, the analysis unit can use a different dataset for each category of the symptom and increase accuracy of an analysis result. Thereby, the analysis unit improves analysis accuracy by applying the optimal analysis algorithm according to the category of the symptom. Specifically, the analysis unit first inputs input data into a “symptom classifier (Classifier)” to identify a rough category (internal disease, surgical trauma, skin disease, etc.). Input to the AI is symptom description text or image data. Output from the AI is an ID of a specialized model to be applied. As subsequent processing, for example, if classified as “skin disease”, the analysis unit calls a CNN model specialized for skin image diagnosis (e.g., a model pre-trained on a skin cancer detection dataset). On the other hand, in the case of “internal disease”, it calls an LLM or Bayesian network model specialized for diagnostic inference based on medical interview data. Thus, by adopting a “Mixture of Experts (MoE)”-like architecture that dynamically switches multiple specialized models (Expert Models) instead of processing everything with a single huge model, high analysis accuracy at a specialist level in each field is achieved.

The analysis unit is configured to estimate an emotion of the user and determine a priority of analysis based on the estimated emotion of the user. The analysis unit estimates the emotion of the user and determines the priority of analysis based on the estimated emotion of the user. The estimation of emotion is performed using, for example, technology such as facial expression recognition or voice analysis, but is not limited to such examples. For example, when the user is in a hurry, the analysis unit preferentially analyzes a symptom with a high degree of urgency. Also, when the user is calm, the analysis unit can perform detailed analysis and provide a more accurate result. Furthermore, when the user feels anxious, the analysis unit can perform analysis while displaying a message giving a sense of security. Thereby, the analysis unit enables quick and appropriate analysis by determining the priority of analysis according to the user's emotion. The estimation of emotion is realized using an emotion estimation function using, for example, an emotion engine or generative AI. The generative AI is text generative AI (e.g., LLM), multimodal generative AI, or the like, but is not limited to such examples. Specifically, the analysis unit implements a scheduling algorithm that assigns a priority tag to each analysis request in a job queue management system on a cloud server. Input to the AI is an emotion score included in request metadata transmitted from the user terminal. Output from the AI is an insertion position (priority) in a job queue. As subsequent processing, a request whose emotion score indicates “panic” is placed at the top of a Priority Queue, and GPU resources are allocated prior to other normal requests. Thereby, even if the system is in a high load state, analysis processing for a user who is psychologically in a hurry is executed without delay, and improvement of User Experience (UX) and speeding up of emergency response are achieved.

The analysis unit is configured to determine a priority of analysis based on a submission time of the symptom at a time of analysis. The analysis unit determines the priority of analysis based on the submission time of the symptom at the time of analysis. The submission time includes, for example, submission date and time, submission frequency, etc., but is not limited to such examples. For example, the analysis unit performs analysis quickly for a symptom submitted late at night, and preferentially analyzes a symptom with a high degree of urgency. Also, the analysis unit can perform detailed analysis for a symptom submitted during the daytime and provide a more accurate result. Furthermore, the analysis unit can adjust the priority of analysis according to the submission time of the symptom and perform analysis efficiently. Thereby, the analysis unit enables quick and appropriate analysis by determining the priority of analysis according to the submission time of the symptom. Specifically, the analysis unit includes logic to calculate a priority score using a timestamp of a request and a risk coefficient by time zone based on medical statistics. Input to the AI is current time, day of the week, and ambulance transport record data in the same time zone in the past. Output from the AI is an urgency weight coefficient based on the time zone. As subsequent processing, for example, a high weight coefficient is assigned to a request received between 2:00 AM and 4:00 AM late at night, and it is routed to a priority lane (Fast Track) of an analysis pipeline. This is based on a statistical tendency that a complaint of symptoms in a late-night band has a higher probability of being serious than in the daytime. Also, when there are requests from the same user continuously in a short time, the priority is dynamically raised because there is a possibility that the symptom is changing suddenly. This resource allocation considering temporal context enables system operation that does not overlook a truly urgent case.

The analysis unit is configured to adjust an order of analysis based on relevance of the symptom at a time of analysis. The analysis unit adjusts the order of analysis based on the relevance of the symptom at the time of analysis. The relevance includes, for example, common points of symptoms, related data, etc., but is not limited to such examples. For example, the analysis unit preferentially analyzes highly relevant symptoms and provides a result quickly. Also, the analysis unit can perform detailed analysis for symptoms with low relevance and provide a more accurate result. Furthermore, the analysis unit can adjust the order of analysis according to the relevance of the symptom and perform analysis efficiently. Thereby, the analysis unit enables efficient analysis by adjusting the order of analysis according to the relevance of the symptom. Specifically, the analysis unit calculates a causal relationship or co-occurrence probability between a plurality of input symptoms (e.g., “fever”, “vomiting”, “rash”) using a medical Knowledge Graph. Input to the AI is a list of symptom keywords. Output from the AI is a relevance score matrix based on a distance between nodes on the Knowledge Graph. As subsequent processing, when a combination of symptoms that are highly relevant to each other and suggest a specific serious disease (e.g., meningitis) is found, the analysis unit groups analysis tasks related to those symptoms and inputs them into an inference model collectively rather than in parallel processing, thereby performing integrated analysis considering interaction. On the other hand, independent symptoms with low relevance are analyzed sequentially and individually. This optimization of a processing flow based on relevance improves diagnostic accuracy for a case having complex symptoms and prevents oversight.

The evaluation unit can estimate an emotion of the user and adjust an evaluation criterion for the degree of urgency based on the estimated emotion of the user. The evaluation unit estimates the emotion of the user and adjusts the evaluation criterion for the degree of urgency based on the estimated emotion of the user. The estimation of the emotion is performed using, for example, technology such as facial expression recognition or voice analysis, but is not limited to such examples. For example, when the user is in a hurry, the evaluation unit preferentially evaluates a symptom with a high degree of urgency. Also, when the user is calm, the evaluation unit can perform a detailed evaluation to provide a more accurate result. Furthermore, when the user feels anxious, the evaluation unit can perform the evaluation while displaying a message that gives a sense of security. Thereby, the evaluation unit can perform a more accurate evaluation by adjusting the evaluation criterion for the degree of urgency in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, the evaluation unit implements a bias adjustment algorithm that corrects a deviation between a subjective complaint (emotion) of the user and objective symptom data. An input to the AI is a physical urgency score calculated from objective vital data (body temperature, pulse, etc.) and a psychological urgency score obtained from an emotion estimation model. An output from the AI is an adjusted urgency threshold used for a final determination. As subsequent processing, when the user is in an extreme panic state, even if the objective symptom is minor, the evaluation unit temporarily lowers the threshold for urgency determination (increases sensitivity) and adjusts to make a determination on the safe side (over-triage) in order to ensure the user's sense of security and avoid a risk of oversight. Conversely, even if the user is too calm, if the objective data indicates danger, the threshold is strictly applied. This human-centric evaluation logic enables a comprehensive determination including not only medical correctness but also psychological care for the user.

The evaluation unit can improve evaluation accuracy of the degree of urgency by considering a mutual relationship between symptoms at a time of evaluation. The evaluation unit improves the evaluation accuracy of the degree of urgency by considering the mutual relationship between symptoms at the time of evaluation. The mutual relationship includes, for example, relevance or correlation of symptoms, but is not limited to such examples. For example, the evaluation unit comprehensively evaluates related symptoms such as fever and rash to determine the degree of urgency. Also, the evaluation unit can adjust an evaluation criterion for the degree of urgency by considering the mutual relationship between symptoms. Furthermore, when a plurality of symptoms occur simultaneously, the evaluation unit can perform a comprehensive evaluation to determine the degree of urgency. Thereby, the evaluation unit improves the evaluation accuracy of the degree of urgency by considering the mutual relationship between symptoms. Specifically, the evaluation unit calculates attention weights between a plurality of input symptom tokens by a neural network using a Self-Attention mechanism, and detects a case where a combination of symptoms that appear minor individually suggests a serious disease. An input to the AI is a list of symptoms and respective elapsed times. An output from the AI is a risk score as a syndrome. As subsequent processing, for example, even if “fever” alone has a low degree of urgency and “stiff neck” alone has a medium degree of urgency, if both exist simultaneously, the evaluation unit performs a non-linear evaluation that raises the degree of urgency to the “highest level” assuming suspicion of “meningitis”. This evaluation considering interaction mimics advanced medical reasoning that cannot be realized by a simple score addition method, and dramatically increases reliability of diagnostic support.

The evaluation unit can evaluate the degree of urgency by considering attribute information of a submitter of the symptom at a time of evaluation. The evaluation unit evaluates the degree of urgency by considering the attribute information of the submitter of the symptom at the time of evaluation. The attribute information includes, for example, age, gender, medical history, etc., but is not limited to such examples. For example, the evaluation unit evaluates the degree of urgency by considering an age or a health condition of a child. Also, the evaluation unit can determine the degree of urgency based on a past health history of the submitter. Furthermore, the evaluation unit can adjust an evaluation criterion for the degree of urgency based on the attribute information of the submitter. Thereby, the evaluation unit enables a more accurate evaluation of the degree of urgency by considering the attribute information of the submitter. Specifically, the evaluation unit encodes the attribute information as a feature vector, combines it with a symptom feature vector, and inputs it to an inference model. An input to the AI is age (normalized numerical value), gender (one-hot vector), and medical history (multi-hot vector or embedding vector). An output from the AI is an urgency probability based on an attribute-specific risk profile. As subsequent processing, for a fever of, for example, an “infant under 3 months old”, the evaluation unit applies an evaluation logic completely different from that for an adult's fever (considering sepsis risk, etc.) and sets the degree of urgency high even for a slight rise in body temperature. Also, for a user with a specific drug allergy, an evaluation taking into account a possibility of side effects related to the drug is performed. This attribute-based personalized evaluation enables precise triage according to a risk specific to the patient, rather than a general/average standard.

The evaluation unit can estimate an emotion of the user and adjust an order of displaying evaluation results of the degree of urgency based on the estimated emotion of the user. The evaluation unit estimates the emotion of the user and adjusts the order of displaying the evaluation results of the degree of urgency based on the estimated emotion of the user. The estimation of the emotion is performed using, for example, technology such as facial expression recognition or voice analysis, but is not limited to such examples. For example, when the user is in a hurry, the evaluation unit preferentially displays a symptom with a high degree of urgency. Also, when the user is calm, the evaluation unit can display detailed evaluation results in order. Furthermore, when the user feels anxious, the evaluation unit can display the evaluation results while displaying a message that gives a sense of security. Thereby, the evaluation unit enables more appropriate information provision by adjusting the display order of the evaluation results in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, the evaluation unit uses a ranking algorithm that assigns a display priority score according to an emotion state of the user to each section (conclusion, reason, detailed data, advice) of a generated evaluation report. An input to the AI is an emotion vector of the user and a content vector of each section of the report. An output from the AI is a display order index for each section. As subsequent processing, when the user is in an “anxious/confused” state, the evaluation unit displays the conclusion (“Please call an ambulance” or “Please wait and see”) largely at the top of a screen and hides medical detailed explanations in a collapsible menu. On the other hand, when the user is “calm/analytical”, data or graphs serving as a basis are displayed first. This optimization of the presentation order of information has an effect of reducing a cognitive load on the user and smoothing decision-making in an emergency.

The evaluation unit can evaluate the degree of urgency by considering a geographical distribution of symptoms at a time of evaluation. The evaluation unit evaluates the degree of urgency by considering the geographical distribution of symptoms at the time of evaluation. The geographical distribution includes, for example, an occurrence frequency of symptoms for each region, a health risk specific to a region, etc., but is not limited to such examples. For example, the evaluation unit evaluates the degree of urgency by considering a disease or symptom prevalent in a specific region. Also, the evaluation unit can adjust an evaluation criterion for the degree of urgency based on the geographical distribution. Furthermore, the evaluation unit can determine the degree of urgency by considering the health risk for each region. Thereby, the evaluation unit enables evaluation of the degree of urgency reflecting the health risk for each region by considering the geographical distribution of symptoms. Specifically, the evaluation unit cooperates with a geographic information system (GIS) and refers to epidemiological heat map data around a current location of the user. An input to the AI is GPS coordinates of the user and an infectious disease epidemic index of a mesh section including the coordinates. An output from the AI is a correction value for a Prior Probability based on a regional risk. As subsequent processing, the evaluation unit uses a framework of Bayesian estimation to multiply a Likelihood calculated from the symptom by this prior probability to calculate the degree of urgency as a Posterior Probability. For example, when a food poisoning warning is issued in a specific region, an urgency evaluation for a complaint of “abdominal pain” from that region is set higher than usual. This integration of spatial context enables a rapid and precise reaction to a region-specific health crisis.

The evaluation unit can improve evaluation accuracy of the degree of urgency by referring to related literature of the symptom at a time of evaluation. The evaluation unit improves the evaluation accuracy of the degree of urgency by referring to the related literature of the symptom at the time of evaluation. The related literature includes, for example, the latest medical literature related to the symptom, past research results, and the like, but is not limited to such examples. For example, the evaluation unit refers to the latest medical literature related to the symptom and evaluates the degree of urgency. In addition, the evaluation unit can also adjust an evaluation criterion for the degree of urgency based on the related literature. Furthermore, the evaluation unit can also determine the degree of urgency by referring to past research results regarding the symptom. Thereby, the evaluation unit improves the evaluation accuracy of the degree of urgency by referring to the related literature. Specifically, the evaluation unit executes a semantic search using a current symptom description as a query against a knowledge base that is periodically crawled and vectorized from a medical literature database such as PubMed. An input to an AI is an embedding vector of the symptom. An output from the AI is a summary text of a medical paper with high similarity and a confidence score thereof. As subsequent processing, the evaluation unit compares a case described in the retrieved literature with the current symptom of the user, and verifies whether there is a sign of a rare disease or a new infectious disease. If a feature matching a severe case in the literature is found, the evaluation unit overwrites a determination result by a standard algorithm and outputs a higher degree of urgency. With this literature reference function, latest medical knowledge and information on rare diseases not included in training data of an AI model can be reflected in the evaluation, and obsolescence of the system can be prevented to constantly maintain state-of-the-art diagnostic accuracy.

The arrangement unit can estimate an emotion of the user and determine a priority of ambulance arrangement based on the estimated emotion of the user. The arrangement unit estimates the emotion of the user and determines the priority of ambulance arrangement based on the estimated emotion of the user. The estimation of the emotion is performed using, for example, technology such as facial expression recognition or voice analysis, but is not limited to such examples. For example, when the user is in a hurry, the arrangement unit quickly arranges an ambulance. Also, when the user is calm, the arrangement unit can perform arrangement of an ambulance based on detailed information. Furthermore, when the user feels anxious, the arrangement unit can arrange an ambulance while displaying a message that gives a sense of security. Thereby, the arrangement unit enables rapid and appropriate arrangement by determining the priority of ambulance arrangement in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, the arrangement unit implements priority control (QoS: Quality of Service) based on an emotion score in an API gateway that manages connection requests to an emergency command center. An input to the AI is an emotion state vector of the user. An output from the AI is a priority class (High, Medium, Low) of an API request. As subsequent processing, an arrangement request from a user who is emotionally extremely unstable is classified into the “High” class, bypasses a processing queue inside the system, and is immediately transmitted to an external system. At the same time, the arrangement unit automatically generates and plays voice guidance such as “Arranging now, please stay calm and wait” to a user terminal to attempt psychological stabilization of the user. This emotion-linked arrangement process not only hastens arrival of a physical ambulance but also has a psychological effect of reducing the user's anxiety during waiting time.

The arrangement unit can adjust a level of detail of arrangement based on the degree of urgency of the symptom at a time of arrangement. The arrangement unit adjusts the level of detail of arrangement based on the degree of urgency of the symptom at the time of arrangement. The adjustment of the level of detail is performed based on, for example, a depth of arrangement or granularity of data, but is not limited to such examples. For example, for a symptom with a high degree of urgency, the arrangement unit performs rapid and detailed arrangement. Also, for a symptom with a low degree of urgency, the arrangement unit can perform simple arrangement and respond quickly. Furthermore, the arrangement unit can adjust a priority of arrangement in accordance with the degree of urgency of the symptom and perform arrangement efficiently. Thereby, the arrangement unit enables efficient arrangement by adjusting the level of detail of arrangement in accordance with the degree of urgency of the symptom. Specifically, the arrangement unit dynamically changes a configuration of a data package to be transmitted to an ambulance crew in accordance with an urgency level. An input to the AI is the urgency level determined by the evaluation unit. An output from the AI is a selection mask (Selection Mask) for transmission data items. As subsequent processing, when the degree of urgency is at the highest level (cardiopulmonary arrest, etc.), the arrangement unit transmits minimal data including only location information and a code “CPA (Cardiopulmonary Arrest)” as a highest priority packet to minimize communication delay. Thereafter, detailed medical history and image data are sent subsequently in the background. On the other hand, when the degree of urgency is medium, a complete data set including past medical history, medication information, site photos, etc., is constructed from the beginning and then transmitted. This adaptive data transmission control realizes effective utilization of communication bandwidth and optimal information sharing according to a situation.

The arrangement unit can apply a different arrangement algorithm in accordance with a category of the symptom at a time of arrangement. The arrangement unit applies a different arrangement algorithm in accordance with the category of the symptom at the time of arrangement. The arrangement algorithm includes, for example, an optimization algorithm, a rule-based method, etc., but is not limited to such examples. For example, the arrangement unit applies an appropriate arrangement algorithm for symptoms of different categories such as fever and injury. Also, the arrangement unit can select an optimal arrangement method in accordance with the category of the symptom and improve arrangement accuracy. Furthermore, the arrangement unit can use a different data set for each category of the symptom and increase accuracy of an arrangement result. Thereby, the arrangement unit improves the arrangement accuracy by applying an optimal arrangement algorithm in accordance with the category of the symptom. Specifically, the arrangement unit switches a selection logic (matching algorithm) for a transport destination medical institution based on a symptom category (e.g., trauma, poisoning, perinatal emergency). An input to the AI is a symptom category ID and function information of surrounding medical institutions (critical care center, perinatal maternal and child medical center, etc.). An output from the AI is a list of optimal transport destination candidates. As subsequent processing, in a case of, for example, “severe burn of a child”, the arrangement unit applies an algorithm that preferentially searches for a specialized hospital having skin graft facilities rather than a general emergency hospital. In a case of “poisoning”, a hospital having a stockpile of antidotes is searched for. In this way, by performing specialized resource matching adapted to characteristics of the symptom, there is a technical effect of preventing being passed around and shortening access time to appropriate treatment.

The arrangement unit can estimate an emotion of the user and adjust an order of arrangement based on the estimated emotion of the user. The arrangement unit estimates the emotion of the user and adjusts the order of arrangement based on the estimated emotion of the user. The estimation of the emotion is performed using, for example, technology such as facial expression recognition or voice analysis, but is not limited to such examples. For example, when the user is in a hurry, the arrangement unit preferentially arranges a symptom with a high degree of urgency. Also, when the user is calm, the arrangement unit can adjust the order of arrangement based on detailed information. Furthermore, when the user feels anxious, the arrangement unit can adjust the order of arrangement while displaying a message that gives a sense of security. Thereby, the arrangement unit enables rapid and appropriate arrangement by adjusting the order of arrangement in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, the arrangement unit uses an emotion score as a variable in a workflow engine that determines an execution order of a plurality of arrangement tasks (ambulance request, contact to family, notification to family doctor). An input to the AI is an emotion state of the user and a task list to be executed. An output from the AI is an optimized task execution sequence. As subsequent processing, when the user is in a panic state, the arrangement unit prioritizes the “ambulance request” most, and performs other notification processes in parallel asynchronously or postpones them. When the user is calm, it is also possible to insert a step of urging consideration of a more appropriate means (visit by taxi, etc.) before the ambulance request. This dynamic reconfiguration of the process according to the emotion realizes a flexible system behavior adapted to urgency of a situation.

The arrangement unit can determine a priority of arrangement based on a submission time of the symptom at a time of arrangement. The arrangement unit determines the priority of arrangement based on the submission time of the symptom at the time of arrangement. The submission time includes, for example, a submission date and time, a submission frequency, etc., but is not limited to such examples. For example, for a symptom submitted at midnight, the arrangement unit performs arrangement quickly and preferentially arranges a symptom with a high degree of urgency. Also, for a symptom submitted during the daytime, the arrangement unit can perform detailed arrangement and provide a more accurate result. Furthermore, the arrangement unit can adjust the priority of arrangement in accordance with the submission time of the symptom and perform arrangement efficiently. Thereby, the arrangement unit enables rapid and appropriate arrangement by determining the priority of arrangement in accordance with the submission time of the symptom. Specifically, the arrangement unit refers to an emergency demand prediction model (time-series analysis AI) by time zone and determines an arrangement strategy by considering resource tightness in a current time zone. An input to the AI is a current time and an ambulance operation rate in an area. An output from the AI is an urgency coefficient for arrangement processing. As subsequent processing, in a time zone where medical resources are scarce such as a midnight zone or a holiday, the arrangement unit applies a logic that lowers a threshold to secure an ambulance at an early stage. Conversely, if it is during the daytime on a weekday, a margin is allowed to consider a wide range of options including alternative means such as a private ambulance or a taxi. This resource management considering a time axis achieves both proper use of ambulances, which are limited social infrastructure, and reliable dispatch to those in need.

The arrangement unit can adjust an order of arrangement based on relevance of the symptom at a time of arrangement. The arrangement unit adjusts the order of arrangement based on the relevance of the symptom at the time of arrangement. The relevance includes, for example, a common point of symptoms, related data, etc., but is not limited to such examples. For example, the arrangement unit preferentially arranges symptoms with high relevance and provides a result quickly. Also, for symptoms with low relevance, the arrangement unit can perform detailed arrangement and provide a more accurate result. Furthermore, the arrangement unit can adjust the order of arrangement in accordance with the relevance of the symptom and perform arrangement efficiently. Thereby, the arrangement unit enables efficient arrangement by adjusting the order of arrangement in accordance with the relevance of the symptom. Specifically, the arrangement unit has a function of clustering a plurality of arrangement requests generated in a short time from the same region or the same household and collectively processing them as a related case (e.g., mass food poisoning or gas leak accident). An input to the AI is an occurrence position, time, and symptom content of the request. An output from the AI is an event cluster ID and an integrated risk level. As subsequent processing, a plurality of requests determined to be highly relevant are notified to an emergency command center not as individual emergency requests but as one “Mass Casualty Incident”, requesting dispatch of many ambulances and command units at once. This has a technical effect of preventing fragmentation of information compared to a case of individual processing and dramatically speeding up an initial response to a large-scale disaster or accident.

The management unit can estimate an emotion of the user and adjust a management method of the pre-registered information based on the estimated emotion of the user. The management unit estimates the emotion of the user and adjusts the management method of the pre-registered information based on the estimated emotion of the user. The estimation of the emotion is performed using, for example, technology such as facial expression recognition or voice analysis, but is not limited to such examples. For example, when the user is in a hurry, the management unit enables quick confirmation of the pre-registered information. Also, when the user is calm, the management unit can manage the pre-registered information based on detailed information. Furthermore, when the user feels anxious, the management unit can manage the pre-registered information while displaying a message that gives a sense of security. Thereby, the management unit enables rapid and appropriate management by adjusting the management method of the pre-registered information in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, the management unit performs a dynamic change of a security level according to an emotion score in an authentication/authorization process when the user performs information update or confirmation. An input to the AI is biometric authentication data of the user and the emotion score. An output from the AI is a required authentication strength (PIN code, biometric authentication, password, etc.). As subsequent processing, when it is estimated that the user is in an emergency (panic state), the management unit activates an “emergency access mode” that omits a part of normally required multi-factor authentication and permits access to medical history data of a child or data disclosure to an ambulance crew with only minimum identity verification. This optimizes a balance between security and availability in an emergency and prevents a delay in information reference in a situation where every second counts.

The management unit can select an optimal management method by referring to past registration information at a time of management. The management unit selects the optimal management method by referring to the past registration information at the time of management. The past registration information includes, for example, a storage period of registration information, a means of reference, etc., but is not limited to such examples. For example, the management unit selects the optimal management method based on the past registration information and performs management efficiently. Also, the management unit can analyze the past registration information and identify an improvement point of the management method. Furthermore, the management unit can adjust a priority of management by referring to the past registration information. Thereby, the management unit can select the optimal management method by referring to the past registration information. Specifically, the management unit includes data lifecycle management AI that automatically moves a storage tier (hot storage, cold storage) based on an access frequency or importance of data. An input to the AI is an access log and a last update date and time of each data record. An output from the AI is a designation of an optimal storage class. As subsequent processing, allergy information or chronic disease data that is frequently referred to is cached in a low-latency in-memory database (Redis, etc.) to be immediately readable. On the other hand, a record of a disease cured several years ago is archived to an inexpensive object storage. This intelligent data placement optimizes storage cost while maintaining a response speed of the entire system.

The management unit can estimate an emotion of the user and determine a priority of management based on the estimated emotion of the user. The management unit estimates the emotion of the user and determines the priority of management based on the estimated emotion of the user. The estimation of the emotion is performed using, for example, technology such as facial expression recognition or voice analysis, but is not limited to such examples. For example, when the user is in a hurry, the management unit preferentially manages important information. Also, when the user is calm, the management unit can determine the priority of management based on detailed information. Furthermore, when the user feels anxious, the management unit can determine the priority of management while displaying a message that gives a sense of security. Thereby, the management unit enables rapid and appropriate management by determining the priority of management in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, the management unit performs priority control based on an emotion score in transaction processing when a data update request or a reference request from the user competes. An input to the AI is a user emotion score of a request issuer. An output from the AI is a commit priority of a transaction. As subsequent processing, a request for “display of insurance card information” from a user who is in a hurry is executed with priority over periodic backup processing being performed in the background, minimizing a lock wait time of a database. This emotion-priority type database management reduces stress of the user and guarantees operability in an emergency.

The management unit can perform weighting of management data based on a submission time of registration information at a time of management. The management unit performs weighting of the management data based on the submission time of the registration information at the time of management. The weighting includes, for example, importance of information, a temporal factor, etc., but is not limited to such examples. For example, the management unit preferentially manages latest registration information and responds quickly. Also, the management unit can perform detailed management for old registration information and update it as necessary. Furthermore, the management unit can perform weighting of the management data in accordance with the submission time of the registration information and perform management efficiently. Thereby, the management unit enables efficient management by performing weighting of the management data in accordance with the submission time of the registration information. Specifically, the management unit applies a “Time Decay Function” that attenuates a reliability score in accordance with freshness of information. An input to the AI is a last update date and time of information and a type of information (body weight, address, etc.). An output from the AI is a reliability weight (0.0 to 1.0) of current information. As subsequent processing, for example, when “body weight” data of a child has not been updated for one year or more, the reliability weight becomes low, and when the analysis unit calculates a dosage of medicine, processing of issuing an alert requesting reconfirmation to the user or writing an age average body weight together as a reference value is performed without using this old body weight data as it is. This data management considering a time axis allows physical information of a child who grows fast to be always accurately reflected in the system, reducing a risk of medical error.

The providing unit can estimate an emotion of the user and adjust a providing method of the coping method based on the estimated emotion of the user. The providing unit estimates the emotion of the user and adjusts the providing method of the coping method based on the estimated emotion of the user. The estimation of the emotion is performed using, for example, technology such as facial expression recognition or voice analysis, but is not limited to such examples. For example, when the user is in a hurry, the providing unit provides a rapid and concise coping method. Also, when the user is calm, the providing unit can provide a detailed coping method. Furthermore, when the user feels anxious, the providing unit can provide the coping method while displaying a message that gives a sense of security. Thereby, the providing unit enables provision of a rapid and appropriate coping method by adjusting the providing method of the coping method in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, the providing unit dynamically inserts an instruction of a “persona” or an “output style” according to an emotion score in prompt engineering to the generative AI (LLM). An input to the AI is content data of the coping method and an emotion label of the user. An output from the AI is a natural language text whose tone and manner are adjusted to the emotion of the user. As subsequent processing, when the user is in a panic state, the providing unit generates an instruction with “conclusion first”, in bullet points and short sentences (“1. Loosen clothes”, “2. Lay down”). On the other hand, for a user feeling anxiety, generation is performed by adding empathic and supportive words such as “It is okay, please calm down and perform the following procedure”. This information provision close to the emotion improves understanding and compliance (instruction observance rate) of the user.

The providing unit can adjust a level of detail of the coping method based on importance of the symptom at a time of providing. The providing unit adjusts the level of detail of the coping method based on the importance of the symptom at the time of providing. The adjustment of the level of detail is performed based on, for example, a depth of information or granularity of data, but is not limited to such examples. For example, for a symptom with a high degree of urgency, the providing unit provides a detailed coping method. Also, for a minor symptom, the providing unit can provide a simple coping method and respond quickly. Furthermore, the providing unit can adjust the level of detail of the coping method in accordance with the importance of the symptom and provide it efficiently. Thereby, the providing unit enables provision of an efficient coping method by adjusting the level of detail of the coping method in accordance with the importance of the symptom. Specifically, the providing unit has a content generation engine that dynamically controls a hierarchical structure of information (summary, detailed procedure, basis, supplementary information). An input to the AI is an importance score of the symptom. An output from the AI is a depth level of an information hierarchy to be displayed. As subsequent processing, when the importance is high (there is a danger to life), the providing unit omits unnecessary explanation entirely and displays only a specific action of life-saving treatment (CPR, etc.) with a large font and an illustration. Conversely, when the importance is low (minor scratch, etc.), educational detailed content including how to clean a wound, how to choose a bandage, and a guideline for consultation is provided. This optimization of an information amount according to the importance encourages a rapid action in an emergency and provides sufficient knowledge in a non-emergency.

The providing unit can estimate an emotion of the user and determine a priority of the coping method based on the estimated emotion of the user. The providing unit estimates the emotion of the user and determines the priority of the coping method based on the estimated emotion of the user. The estimation of the emotion is performed using, for example, technology such as facial expression recognition or voice analysis, but is not limited to such examples. For example, when the user is in a hurry, the providing unit preferentially provides a coping method with a high degree of urgency. Also, when the user is calm, the providing unit can provide detailed coping methods in order. Furthermore, when the user feels anxious, the providing unit can provide the coping method while displaying a message that gives a sense of security. Thereby, the providing unit enables provision of a rapid and appropriate coping method by determining the priority of the coping method in accordance with the emotion of the user. The estimation of the emotion is realized using an emotion estimation function using, for example, an emotion engine or generative AI. The generative AI is text generative AI (e.g., LLM), multimodal generative AI, or the like, but is not limited to such examples. Specifically, when there are a plurality of coping method candidates (e.g., cooling, hydration, rest), the providing unit uses a reranking model that ranks them based on an emotion state of the user. An input to the AI is a coping method candidate list and an emotion vector of the user. An output from the AI is a resorted coping method list. As subsequent processing, for a user who is in a hurry, a coping method that is immediate and easy to execute (e.g., “Open a window to ventilate”) is placed at the top of the list. A coping method that takes time or requires preparation is placed at the bottom. By this prioritization, the user can take a first action without hesitation, and aggravation of a situation can be prevented.

The providing unit can determine a priority of the coping method based on a submission time of the symptom at a time of providing. The providing unit determines the priority of the coping method based on the submission time of the symptom at the time of providing. The submission time includes, for example, a submission date and time, a submission frequency, etc., but is not limited to such examples. For example, for a symptom submitted at midnight, the providing unit provides a coping method quickly and preferentially provides a coping method with a high degree of urgency. Also, for a symptom submitted during the daytime, the providing unit can provide a detailed coping method and provide a more accurate result. Furthermore, the providing unit can determine the priority of the coping method in accordance with the submission time of the symptom and provide it efficiently. Thereby, the providing unit enables provision of a rapid and appropriate coping method by determining the priority of the coping method in accordance with the submission time of the symptom. Specifically, the providing unit filters coping methods by considering accessibility of medical institutions for each time zone and resources executable at home (cannot go to a pharmacy at midnight, etc.). An input to the AI is a current time and business hour data of surrounding facilities. An output from the AI is a coping method list with a feasibility score. As subsequent processing, if it is midnight, “consultation at emergency outpatient” or “use of antipyretic on hand” is preferentially proposed, and “purchase at drugstore” is excluded from options or displayed at the bottom. This proposal logic considering a temporal constraint eliminates advice that is realistically impossible to execute and provides only information useful for the user.

The processing unit is configured to estimate an emotion of the user and adjust a processing method for image or video data based on the estimated emotion of the user. The processing unit estimates the emotion of the user and adjusts the processing method for the image or video data based on the estimated emotion of the user. Estimation of the emotion is performed using, for example, technology such as facial expression recognition or voice analysis, but is not limited to such examples. For example, when the user is impatient, the processing unit processes the image or video data rapidly and provides a result. Also, when the user is calm, the processing unit can perform detailed processing and provide a more accurate result. Furthermore, when the user feels anxious, the processing unit can also process the image or video data while displaying a message giving a sense of security. Thereby, the processing unit adjusts the processing method for the image or video data in accordance with the emotion of the user, thereby enabling rapid and appropriate processing. Estimation of the emotion is realized using an emotion estimation function using, for example, an emotion engine or generative AI. The generative AI is text generation AI (e.g., LLM), multimodal generation AI, or the like, but is not limited to such examples. Specifically, the processing unit has a parameter tuning function that dynamically changes a configuration (resolution, frame rate, number of applied filters) of an image processing pipeline. An input to the AI is an emotion score of the user. An output from the AI is an image processing parameter set (e.g., resizing coefficient, quantization bit number of an inference model). As subsequent processing, when the user is impatient, the processing unit resizes an image to a low resolution and returns an analysis result in several milliseconds using a lightweight inference model (MobileNet, etc.). When the user is calm, the processing unit uses a high-precision model (EfficientNet-B7, etc.) with an original resolution. By this dynamic trade-off control of processing quality and speed, maximum performance is exhibited within a psychological tolerance range of the user.

The processing unit can adjust a level of detail of processing based on importance of data at a time of processing. The processing unit adjusts the level of detail of processing based on the importance of data at the time of processing. Adjustment of the level of detail is performed based on, for example, a depth of data or granularity of processing, but is not limited to such examples. For example, the processing unit performs detailed processing on data with a high degree of urgency. Also, the processing unit can perform simple processing on mild data to respond rapidly. Furthermore, the processing unit can also adjust the level of detail of processing in accordance with the importance of data to perform processing efficiently. Thereby, the processing unit adjusts the level of detail of processing in accordance with the importance of data, thereby enabling efficient processing. Specifically, the processing unit has conditional branch logic that first performs simple anomaly detection (Anomaly Detection) on input data (image or video) and determines whether or not to execute subsequent detailed analysis based on an anomaly score (importance) thereof. An input to the AI is a feature vector of an image. An output from the AI is an anomaly score (0.0 to 1.0). As subsequent processing, when the anomaly score is high (e.g., massive bleeding or cyanosis is suspected), the processing unit transfers the image to a high-performance GPU instance on a cloud and performs high-load processing such as pixel-level semantic segmentation or 3D reconstruction. When the anomaly score is low, only simple processing is performed on an edge device side. By this hierarchical processing architecture, an analysis depth for a significant case is secured while saving a communication bandwidth and a calculation cost.

The system according to the embodiment is not limited to the above-described examples, and various changes are possible, for example, as follows. Specifically, the present system can be implemented not only as a single server configuration but also as a distributed ledger system using blockchain technology, ensuring tamper resistance and transparency of medical data. Also, a configuration in which AI models are distributedly arranged in edge computing nodes of a 5G/6G communication network to realize inference with ultra-low latency may be adopted. Furthermore, it is also possible to extend to a proactive system in which the system cooperates with a wearable device (smart watch, etc.) to perform constant vital monitoring, thereby detecting a sign before the user inputs a symptom and causing the AI to actively ask a question.

The reception unit is configured to analyze a past symptom input history of the user and propose an optimal input method. For example, based on symptoms input by the user in the past, the reception unit automatically displays frequently input symptoms as candidates. Also, the reception unit can preferentially propose an input method (voice, text, etc.) used by the user in the past. Furthermore, the reception unit can also predict and propose a symptom input in a specific time zone from the past symptom input history of the user. Thereby, the reception unit can propose the optimal input method to the user by analyzing the past symptom input history. Specifically, the reception unit constructs an input tendency model for each user using a recommendation algorithm such as collaborative filtering or matrix factorization. An input to the AI is 3-dimensional tensor data of user×symptom×time zone. An output from the AI is a recommendation score of each symptom and input method. As subsequent processing, based on this score, arrangement of shortcut buttons on a UI or a default input mode (keyboard or microphone) is automatically set. Thereby, the user can input information by an optimal means reflexively without thinking, reducing an operation error in an emergency.

The evaluation unit is configured to estimate an emotion of the user and adjust an evaluation criterion for the degree of urgency based on the estimated emotion of the user. For example, when the user is impatient, the evaluation unit preferentially evaluates a symptom with a high degree of urgency. Also, when the user is calm, the evaluation unit can perform detailed evaluation and provide a more accurate result. Furthermore, when the user feels anxious, the evaluation unit can also perform evaluation while displaying a message giving a sense of security. Thereby, the evaluation unit adjusts the evaluation criterion for the degree of urgency in accordance with the emotion of the user, thereby enabling more accurate evaluation. Specifically, the evaluation unit may adopt a reinforcement learning model that uses an emotion score as a weighting parameter of a loss function. An input to the AI is symptom data, an emotion state, and feedback (correct label) for a past evaluation result. An output from the AI is a policy for degree of urgency determination. As subsequent processing, for an impatient user, an evaluation criterion in which a penalty for a false negative (oversight) is set large is applied to make a judgment leaning toward a safe side. Thereby, a sophisticated evaluation system incorporating a psychological state of the user as a part of risk management is realized.

The providing unit is configured to estimate an emotion of the user and adjust a providing method of the coping method based on the estimated emotion of the user. For example, when the user is impatient, the providing unit provides a rapid and concise coping method. Also, when the user is calm, the providing unit can provide a detailed coping method. Furthermore, when the user feels anxious, the providing unit can also provide the coping method while displaying a message giving a sense of security. Thereby, the providing unit adjusts the providing method of the coping method in accordance with the emotion of the user, thereby enabling provision of a rapid and appropriate coping method. Specifically, the providing unit includes a function of controlling parameters (speech speed, pitch, intonation) of a text-to-speech (TTS) engine based on an emotion recognition result. An input to the AI is a generated coping method text and an emotion score. An output from the AI is waveform data of synthesized speech. As subsequent processing, for an impatient user, the providing unit reads aloud in a calm low tone and at a slow tempo, thereby giving a sedative effect auditorily as well. By optimizing not only visual information but also auditory information, transmission efficiency of information is maximized.

The processing unit is configured to estimate an emotion of the user and adjust a processing method for image or video data based on the estimated emotion of the user. For example, when the user is impatient, the processing unit processes the image or video data rapidly and provides a result. Also, when the user is calm, the processing unit can perform detailed processing and provide a more accurate result. Furthermore, when the user feels anxious, the processing unit can also process the image or video data while displaying a message giving a sense of security. Thereby, the processing unit adjusts the processing method for the image or video data in accordance with the emotion of the user, thereby enabling rapid and appropriate processing. Specifically, the processing unit performs control to display an analysis result stepwise, similarly to progressive download technology. An input to the AI is a processing progress status and an emotion score of the user. An output from the AI is a display timing control signal for an intermediate result. As subsequent processing, for an impatient user, even before a final definitive diagnosis is issued, the processing unit sequentially provides feedback in real time starting from a completed portion (e.g., “amount of bleeding is not large”), thereby resolving anxiety about waiting time.

The arrangement unit is configured to estimate an emotion of the user and determine a priority of ambulance arrangement based on the estimated emotion of the user. For example, when the user is impatient, the arrangement unit arranges an ambulance rapidly. Also, when the user is calm, the arrangement unit can arrange an ambulance based on detailed information. Furthermore, when the user feels anxious, the arrangement unit can also arrange an ambulance while displaying a message giving a sense of security. Thereby, the arrangement unit determines the priority of ambulance arrangement in accordance with the emotion of the user, thereby enabling rapid and appropriate arrangement. Specifically, the arrangement unit incorporates an emotion score into a cost function of an ambulance routing algorithm (a variant of the traveling salesman problem). An input to the AI is a geographical coordinate of each request point and an emotional degree of urgency of the user. An output from the AI is an optimal dispatch route and order. As subsequent processing, if medical degrees of urgency are comparable, the arrangement unit optimizes a route so as to preferentially dispatch a vehicle to a user who is emotionally in a panic state, thereby settling confusion at a scene at an early stage.

The management unit is configured to analyze past registration information of the user and select an optimal management method. For example, based on the past registration information, the management unit selects the optimal management method and performs management efficiently. Also, the management unit can analyze the past registration information and identify an improvement point of the management method. Furthermore, the management unit can also refer to the past registration information and adjust a priority of management. Thereby, the management unit can select the optimal management method by referring to the past registration information. Specifically, the management unit uses an unsupervised learning model (clustering, etc.) that learns a usage pattern of data to automatically classify data into categories such as “constant use”, “use only in emergency”, and “archive”. An input to the AI is an access history feature amount of each data item. An output from the AI is a data management policy class. As subsequent processing, based on this classification, the management unit automatically adjusts a backup frequency or encryption strength of data, thereby optimizing a balance between an operation cost and security.

The evaluation unit is configured to improve evaluation accuracy of the degree of urgency by considering a mutual relationship between symptoms. For example, the evaluation unit comprehensively evaluates related symptoms such as a fever and a rash to determine the degree of urgency. Also, the evaluation unit can consider the mutual relationship between symptoms and adjust an evaluation criterion for the degree of urgency. Furthermore, when a plurality of symptoms are occurring simultaneously, the evaluation unit can perform comprehensive evaluation to determine the degree of urgency. Thereby, the evaluation unit considers the mutual relationship between symptoms, whereby the evaluation accuracy of the degree of urgency improves. Specifically, the evaluation unit analyzes graph structure data having symptoms as nodes and causal relationships between symptoms as edges using a graph neural network (GNN). An input to the AI is a subgraph constructed from a symptom group complained of by the user. An output from the AI is a risk classification label of the entire graph. As subsequent processing, the evaluation unit determines the degree of urgency based on a topology feature (connectivity or centrality) as a graph structure rather than a sum of risk values of individual symptom nodes, thereby detecting a complex syndrome with high precision.

The providing unit is configured to determine a priority of the coping method based on a submission time of the symptom. For example, for a symptom submitted at midnight, the providing unit rapidly provides a coping method and preferentially provides a coping method with a high degree of urgency. Also, for a symptom submitted during the daytime, the providing unit can provide a detailed coping method and provide a more accurate result. Furthermore, the providing unit can also adjust the priority of the coping method in accordance with the submission time of the symptom to provide the coping method efficiently. Thereby, the providing unit determines the priority of the coping method in accordance with the submission time of the symptom, thereby enabling provision of a rapid and appropriate coping method. Specifically, the providing unit has a coping method database considering a circadian rhythm. An input to the AI is a current time and biological rhythm estimation data of the user. An output from the AI is a recommendation list of coping methods suitable for a time zone (e.g., taking medicine before going to bed, seeing a doctor first thing in the morning). As subsequent processing, in a late-night zone, the providing unit prioritizes a coping method that does not disturb sleep (cooling quietly, etc.), giving consideration not to disrupt a living rhythm of the user.

The arrangement unit is configured to apply a different arrangement algorithm in accordance with a category of the symptom. For example, the arrangement unit applies an appropriate arrangement algorithm to symptoms of different categories such as a fever and an injury. Also, the arrangement unit can select an optimal arrangement technique in accordance with the category of the symptom and improve arrangement accuracy. Furthermore, the arrangement unit can also use a different data set for each category of the symptom to increase accuracy of an arrangement result. Thereby, the arrangement unit applies the optimal arrangement algorithm in accordance with the category of the symptom, whereby the arrangement accuracy improves. Specifically, the arrangement unit implements dispatch logic specialized for each symptom category (e.g., logic for infectious disease, logic for trauma) as a microservice. An input to the AI is a symptom category ID. An output from the AI is an endpoint URL of a microservice to be called. As subsequent processing, in the case of an infectious disease category, the arrangement unit performs filtering to include a special ambulance equipped with infection prevention measures (isolator, etc.) in a search target, and arranges a vehicle having appropriate equipment and materials.

The processing unit can adjust a level of detail of processing based on importance of data. For example, the processing unit performs detailed processing on data with a high degree of urgency. Also, the processing unit can perform simple processing on mild data to respond rapidly. Furthermore, the processing unit can also adjust the level of detail of processing in accordance with the importance of data to perform processing efficiently. Thereby, the processing unit adjusts the level of detail of processing in accordance with the importance of data, thereby enabling efficient processing. Specifically, the processing unit calculates information entropy or a saliency map (Saliency Map) of input data and applies an “attention mechanism (Attention Mechanism)” that selectively processes only a region with a large amount of information at a high resolution to image processing. An input to the AI is image data. An output from the AI is a coordinate of a region of interest (ROI) to be processed. As subsequent processing, by skipping processing of an unimportant region such as a background, calculation amount is significantly reduced while maintaining analysis accuracy of an affected part.

A flow of processing of Example of the Embodiment will be briefly described below. Specifically, a data flow in the present system is configured as a series of sequences including an uplink from a user terminal (edge) to a cloud server, an AI inference pipeline in a cloud, and a downlink from the cloud to the user terminal and an external institution, and each step is efficiently controlled by an asynchronous and event-driven architecture.

Step 1: The reception unit receives a symptom input from a user. The symptom input from the user includes a text input, a voice input, an image input, and the like. For example, the reception unit accepts that the user inputs “a child has a high fever” by text, explains a symptom by voice, or transmits image or video data.

Step 2: The analysis unit analyzes symptom data received by the reception unit using generative AI. Analysis is performed based on an algorithm to be used or accuracy of analysis. For example, the analysis unit analyzes text data using text generation AI, analyzes image data using image generation AI, and analyzes video data using multimodal generation AI.

Step 3: The evaluation unit evaluates a degree of urgency based on data analyzed by the analysis unit. Evaluation of the degree of urgency is performed based on a severity of a symptom or a temporal factor. For example, the evaluation unit evaluates that the degree of urgency is high when a high fever continues or a degree of an injury is serious, and evaluates that the degree of urgency is low when a symptom is mild.

Step 4: The arrangement unit arranges an ambulance based on the degree of urgency evaluated by the evaluation unit. Arrangement is performed based on a priority of arrangement or a means of arrangement. For example, the arrangement unit arranges an ambulance rapidly when the degree of urgency is high, and provides an appropriate coping method to the user when the degree of urgency is low. Specifically, in Step 1, the reception unit receives multimodal data through an HTTPS protocol, performs validation of a data format, and then saves the data in a temporary storage (S3 bucket, etc.) and simultaneously registers an analysis job in a queue. In Step 2, the analysis unit acquires the job from the queue, feeds the data to a Transformer model and a CNN model on a GPU cluster, and executes feature amount extraction and inference. An input to the AI is normalized tensor data, and an output is a probability distribution vector of each symptom class. In Step 3, the evaluation unit performs weighting on the probability distribution vector using pre-registered user attributes (age, medical history) to calculate a final degree of urgency score (0 to 100). At this time, by threshold determination logic, classification is made such that if the score is 80 or more, it is “emergency”, if 50 to 79, “semi-emergency”, and if less than that, “non-emergency”. In Step 4, the arrangement unit immediately calls an emergency API to make a dispatch request for a transaction determined as “emergency”, while in the case of determination as “non-emergency”, the arrangement unit generates a coping method text using generative AI (LLM) and transmits the text as a push notification to a user application. This series of flows is managed by a state machine (AWS Step Functions, etc.), and success/failure or timeout of each step is strictly monitored, thereby ensuring reliability as a mission-critical system.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of a plurality of elements including the above-described reception unit, analysis unit, evaluation unit, arrangement unit, management unit, providing unit, and processing unit is implemented by, for example, at least one of a smart device 14 and a data processing device 12. For example, the reception unit is implemented by a control unit 46A of the smart device 14, and receives a symptom input from a user. The analysis unit is implemented by a specific processing unit 290 of the data processing device 12, and analyzes symptom data using a generative AI. The evaluation unit is implemented by the specific processing unit 290 of the data processing device 12, and evaluates a degree of urgency based on the analyzed data. The arrangement unit is implemented by the specific processing unit 290 of the data processing device 12, and arranges an ambulance based on the degree of urgency. The management unit is implemented by the specific processing unit 290 of the data processing device 12, and manages pre-registered information. The providing unit is implemented by the control unit 46A of the smart device 14, and provides a coping method corresponding to a symptom. The processing unit is implemented by the control unit 46A of the smart device 14, and processes image or video data. The correspondence relationship between each unit and the device or the control unit is not limited to the above-described example, and various modifications are possible.

### Second Embodiment

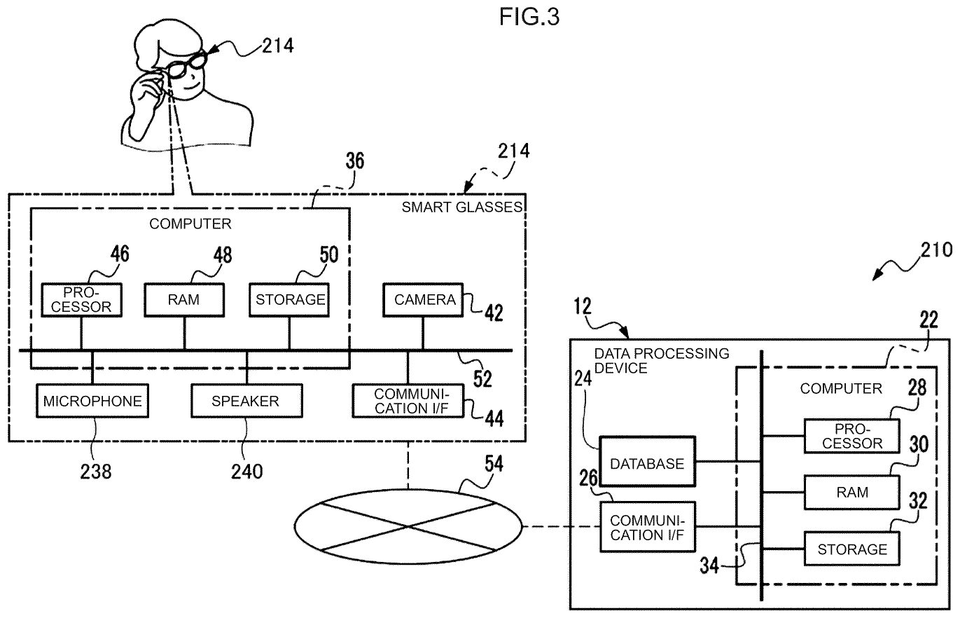

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

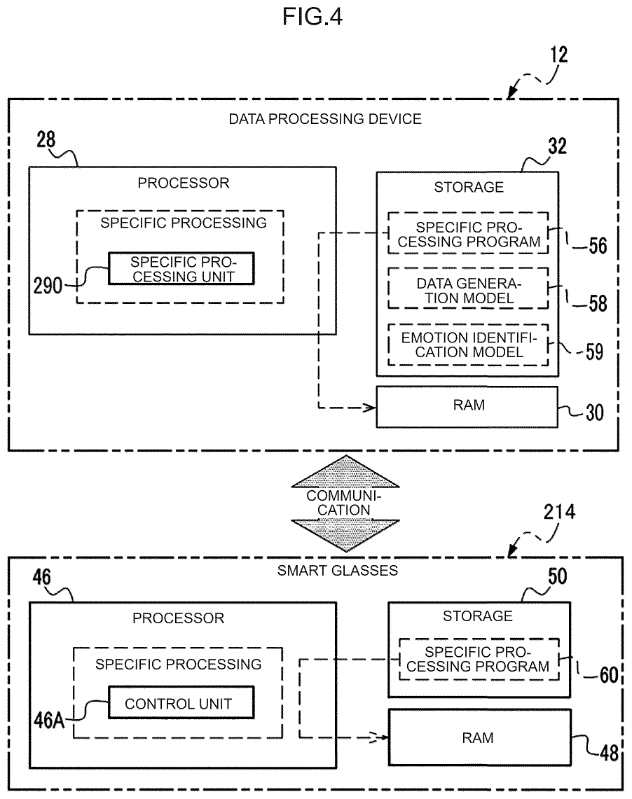

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of a plurality of elements including the above-described reception unit, analysis unit, evaluation unit, arrangement unit, management unit, providing unit, and processing unit is implemented by, for example, at least one of smart glasses 214 and the data processing device 12. For example, the reception unit is implemented by a control unit 46A of the smart glasses 214, and receives a symptom input from a user. The analysis unit is implemented by a specific processing unit 290 of the data processing device 12, and analyzes symptom data using a generative AI. The evaluation unit is implemented by the specific processing unit 290 of the data processing device 12, and evaluates a degree of urgency based on the analyzed data. The arrangement unit is implemented by the specific processing unit 290 of the data processing device 12, and arranges an ambulance based on the degree of urgency. The management unit is implemented by the specific processing unit 290 of the data processing device 12, and manages pre-registered information. The providing unit is implemented by the control unit 46A of the smart glasses 214, and provides a coping method corresponding to a symptom. The processing unit is implemented by the control unit 46A of the smart glasses 214, and processes image or video data. The correspondence relationship between each unit and the device or the control unit is not limited to the above-described example, and various modifications are possible.

### Third Embodiment

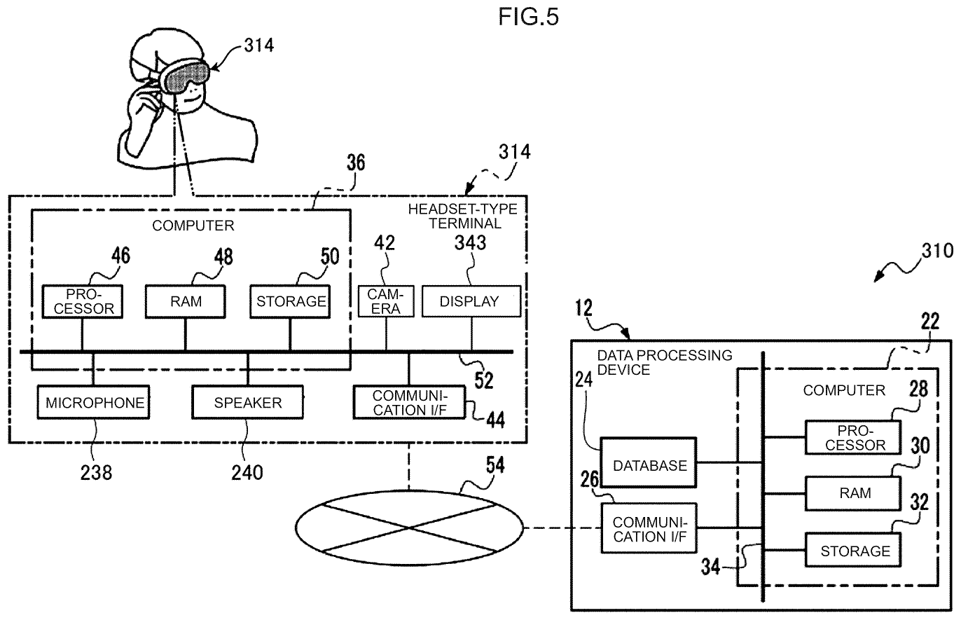

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

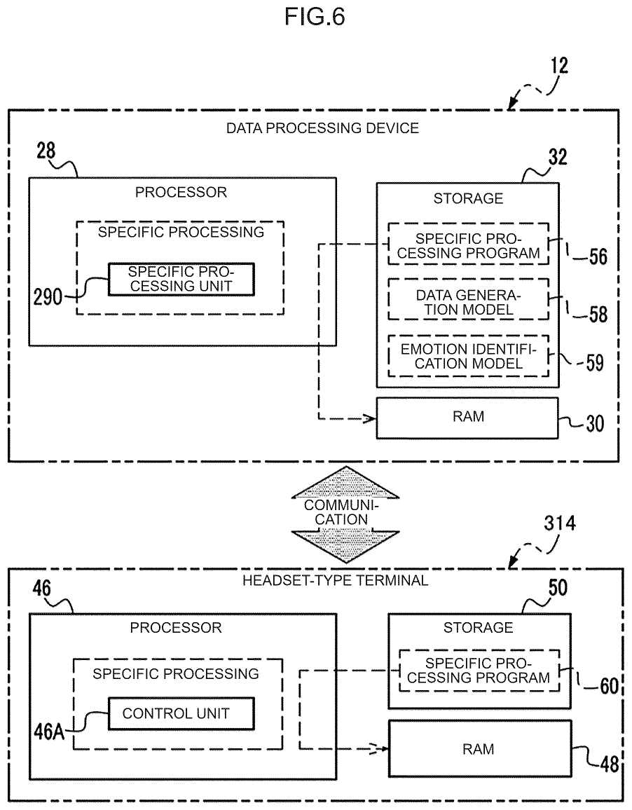

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of a plurality of elements including the above-described reception unit, analysis unit, evaluation unit, arrangement unit, management unit, providing unit, and processing unit is implemented by, for example, at least one of a headset-type terminal 314 and the data processing device 12. For example, the reception unit is implemented by a control unit 46A of the headset-type terminal 314, and receives a symptom input from a user. The analysis unit is implemented by a specific processing unit 290 of the data processing device 12, and analyzes symptom data using a generative AI. The evaluation unit is implemented by the specific processing unit 290 of the data processing device 12, and evaluates a degree of urgency based on the analyzed data. The arrangement unit is implemented by the specific processing unit 290 of the data processing device 12, and arranges an ambulance based on the degree of urgency. The management unit is implemented by the specific processing unit 290 of the data processing device 12, and manages pre-registered information. The providing unit is implemented by the control unit 46A of the headset-type terminal 314, and provides a coping method corresponding to a symptom. The processing unit is implemented by the control unit 46A of the headset-type terminal 314, and processes image or video data. The correspondence relationship between each unit and the device or the control unit is not limited to the above-described example, and various modifications are possible.

### Fourth Embodiment

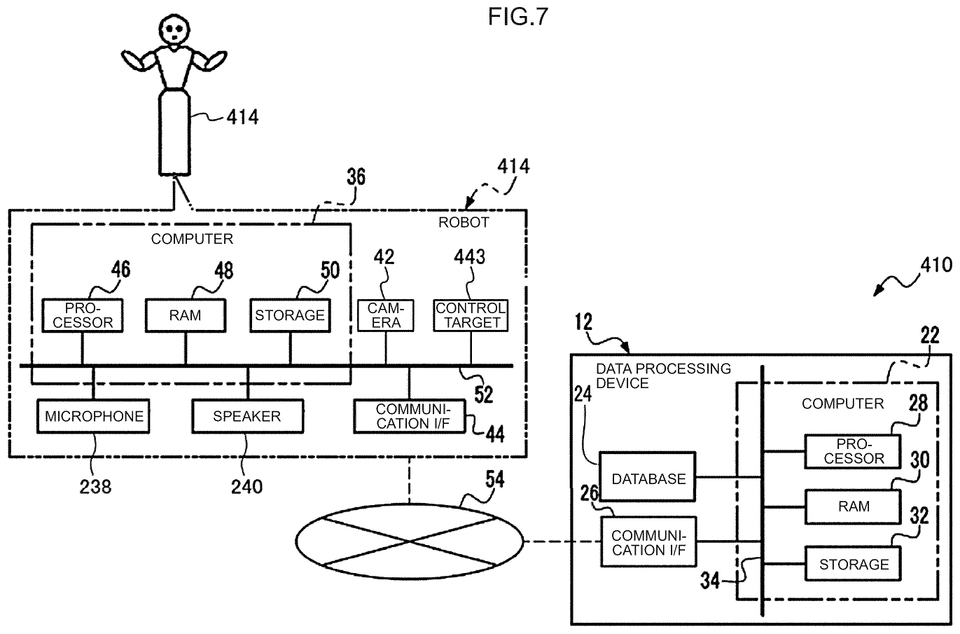

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

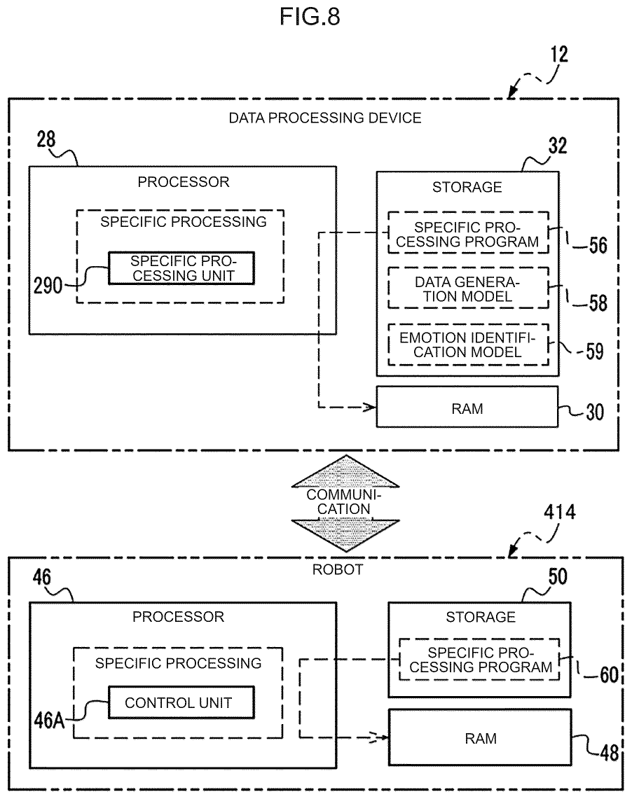

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of a plurality of elements including the above-described reception unit, analysis unit, evaluation unit, arrangement unit, management unit, providing unit, and processing unit is implemented by, for example, at least one of a robot 414 and the data processing device 12. For example, the reception unit is implemented by a control unit 46A of the robot 414, and receives a symptom input from a user. The analysis unit is implemented by a specific processing unit 290 of the data processing device 12, and analyzes symptom data using a generative AI. The evaluation unit is implemented by the specific processing unit 290 of the data processing device 12, and evaluates a degree of urgency based on the analyzed data. The arrangement unit is implemented by the specific processing unit 290 of the data processing device 12, and arranges an ambulance based on the degree of urgency. The management unit is implemented by the specific processing unit 290 of the data processing device 12, and manages pre-registered information. The providing unit is implemented by the control unit 46A of the robot 414, and provides a coping method corresponding to a symptom. The processing unit is implemented by the control unit 46A of the robot 414, and processes image or video data. The correspondence relationship between each unit and the device or the control unit is not limited to the above-described example, and various modifications are possible.

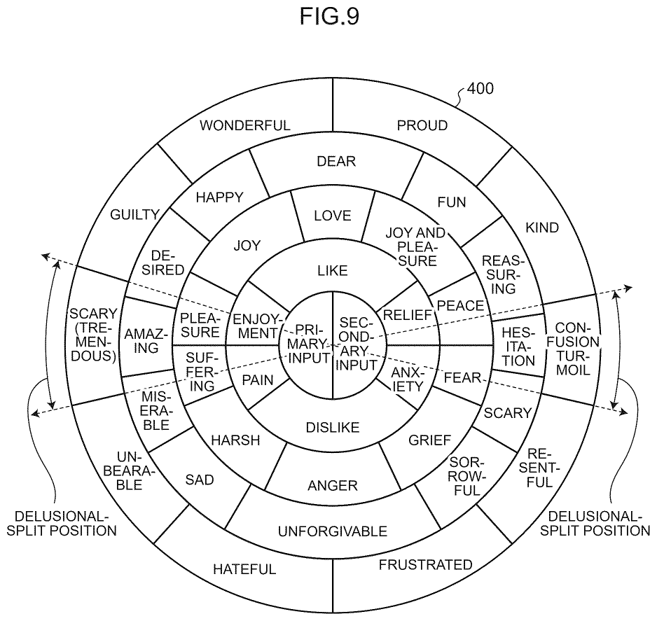

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

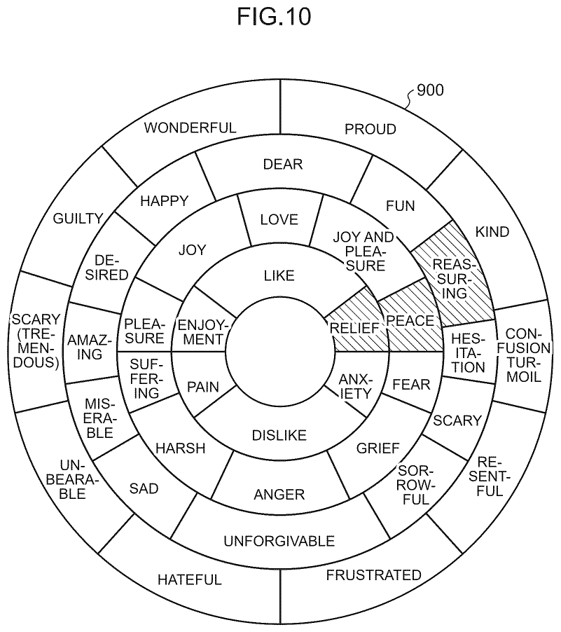

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a reception unit configured to receive a symptom input from a user; an analysis unit configured to analyze symptom data received by the reception unit; an evaluation unit configured to evaluate a degree of urgency based on data analyzed by the analysis unit; and an arrangement unit configured to arrange an ambulance based on the degree of urgency evaluated by the evaluation unit.
(Supplementary Note 2) The system according to Supplementary Note 1, further comprising a management unit configured to manage pre-registered information.
(Supplementary Note 3) The system according to Supplementary Note 1, further comprising a providing unit configured to provide a coping method corresponding to a symptom.
(Supplementary Note 4) The system according to Supplementary Note 1, further comprising a processing unit configured to process image or video data.
(Supplementary Note 5) The system according to Supplementary Note 1, wherein the reception unit is configured to also receive image or video data as necessary when receiving the symptom input from the user.
(Supplementary Note 6) The system according to Supplementary Note 1, wherein the evaluation unit is configured to evaluate the degree of urgency of the symptom based on pre-registered information on a child or an address.
(Supplementary Note 7) The system according to Supplementary Note 1, wherein the reception unit is configured to estimate an emotion of the user and adjust an interface for the symptom input based on the estimated emotion of the user.
(Supplementary Note 8) The system according to Supplementary Note 1, wherein the reception unit is configured to analyze a past symptom input history of the user and propose an optimal input method.
(Supplementary Note 9) The system according to Supplementary Note 1, wherein the reception unit is configured to customize an input method based on a current environment of the user at a time of the symptom input.
(Supplementary Note 10) The system according to Supplementary Note 1, wherein the reception unit is configured to estimate an emotion of the user and determine a priority of the symptom input based on the estimated emotion of the user.
(Supplementary Note 11) The system according to Supplementary Note 1, wherein the reception unit is configured to preferentially input a highly relevant symptom in consideration of geographical location information of the user at a time of the symptom input.
(Supplementary Note 12) The system according to Supplementary Note 1, wherein the reception unit is configured to analyze a social media activity of the user and input a relevant symptom at a time of the symptom input.
(Supplementary Note 13) The system according to Supplementary Note 1, wherein the analysis unit is configured to estimate an emotion of the user and adjust accuracy of analysis based on the estimated emotion of the user.
(Supplementary Note 14) The system according to Supplementary Note 1, wherein the analysis unit is configured to adjust a level of detail of analysis based on importance of the symptom at a time of analysis.
(Supplementary Note 15) The system according to Supplementary Note 1, wherein the analysis unit is configured to apply a different analysis algorithm in accordance with a category of the symptom at a time of analysis.
(Supplementary Note 16) The system according to Supplementary Note 1, wherein the analysis unit is configured to estimate an emotion of the user and determine a priority of analysis based on the estimated emotion of the user.
(Supplementary Note 17) The system according to Supplementary Note 1, wherein the analysis unit is configured to determine a priority of analysis based on a submission time of the symptom at a time of analysis.
(Supplementary Note 18) The system according to Supplementary Note 1, wherein the analysis unit is configured to adjust an order of analysis based on relevance of the symptom at a time of analysis.
(Supplementary Note 19) The system according to Supplementary Note 1, wherein the evaluation unit is configured to estimate an emotion of the user and adjust an evaluation criterion for the degree of urgency based on the estimated emotion of the user.
(Supplementary Note 20) The system according to Supplementary Note 1, wherein the evaluation unit is configured to improve evaluation accuracy of the degree of urgency by considering a mutual relationship between symptoms at a time of evaluation.
(Supplementary Note 21) The system according to Supplementary Note 1, wherein the evaluation unit is configured to evaluate the degree of urgency by considering attribute information of a submitter of the symptom at a time of evaluation.
(Supplementary Note 22) The system according to Supplementary Note 1, wherein the evaluation unit is configured to estimate an emotion of the user and adjust an order of displaying evaluation results of the degree of urgency based on the estimated emotion of the user.
(Supplementary Note 23) The system according to Supplementary Note 1, wherein the evaluation unit is configured to evaluate the degree of urgency by considering a geographical distribution of symptoms at a time of evaluation.
(Supplementary Note 24) The system according to Supplementary Note 1, wherein the evaluation unit is configured to improve evaluation accuracy of the degree of urgency by referring to related literature of the symptom at a time of evaluation.
(Supplementary Note 25) The system according to Supplementary Note 1, wherein the arrangement unit is configured to estimate an emotion of the user and determine a priority of ambulance arrangement based on the estimated emotion of the user.
(Supplementary Note 26) The system according to Supplementary Note 1, wherein the arrangement unit is configured to adjust a level of detail of arrangement based on the degree of urgency of the symptom at a time of arrangement.
(Supplementary Note 27) The system according to Supplementary Note 1, wherein the arrangement unit is configured to apply a different arrangement algorithm in accordance with a category of the symptom at a time of arrangement.
(Supplementary Note 28) The system according to Supplementary Note 1, wherein the arrangement unit is configured to estimate an emotion of the user and adjust an order of arrangement based on the estimated emotion of the user.
(Supplementary Note 29) The system according to Supplementary Note 1, wherein the arrangement unit is configured to determine a priority of arrangement based on a submission time of the symptom at a time of arrangement.
(Supplementary Note 30) The system according to Supplementary Note 1, wherein the arrangement unit is configured to adjust an order of arrangement based on relevance of the symptom at a time of arrangement.
(Supplementary Note 31) The system according to Supplementary Note 2, wherein the management unit is configured to estimate an emotion of the user and adjust a management method of the pre-registered information based on the estimated emotion of the user.
(Supplementary Note 32) The system according to Supplementary Note 2, wherein the management unit is configured to select an optimal management method by referring to past registration information at a time of management.
(Supplementary Note 33) The system according to Supplementary Note 2, wherein the management unit is configured to estimate an emotion of the user and determine a priority of management based on the estimated emotion of the user.
(Supplementary Note 34) The system according to Supplementary Note 2, wherein the management unit is configured to perform weighting of management data based on a submission time of registration information at a time of management.
(Supplementary Note 35) The system according to Supplementary Note 3, wherein the providing unit is configured to estimate an emotion of the user and adjust a providing method of the coping method based on the estimated emotion of the user.
(Supplementary Note 36) The system according to Supplementary Note 3, wherein the providing unit is configured to adjust a level of detail of the coping method based on importance of the symptom at a time of providing.
(Supplementary Note 37) The system according to Supplementary Note 3, wherein the providing unit is configured to estimate an emotion of the user and determine a priority of the coping method based on the estimated emotion of the user.
(Supplementary Note 38) The system according to Supplementary Note 3, wherein the providing unit is configured to determine a priority of the coping method based on a submission time of the symptom at a time of providing.
(Supplementary Note 39) The system according to Supplementary Note 4, wherein the processing unit is configured to estimate an emotion of the user and adjust a processing method for the image or video data based on the estimated emotion of the user.
(Supplementary Note 40) The system according to Supplementary Note 4, wherein the processing unit is configured to adjust a level of detail of processing based on importance of data at a time of processing.

What is claimed is:

1. A system comprising:
circuitry configured to:
receive, via a communication interface coupled to a packet-switched network, multimodal input data from a client terminal, the multimodal input data comprising at least one of text data, image data, and audio data;
extract a feature vector from the multimodal input data by applying a neural network comprising a Transformer-based encoder for the text data and a convolutional neural network for the image data, and fuse outputs of the Transformer-based encoder and the convolutional neural network into a multidimensional tensor using a cross-attention mechanism;
generate a classification label and a probability score by applying a classifier to the multidimensional tensor; and
transmit, via the packet-switched network, a dispatch signal to an external system when the probability score exceeds a predetermined threshold, the dispatch signal comprising location data associated with the client terminal.

2. The system according to claim 1, wherein the circuitry is further configured to manage pre-registered attribute data associated with a user of the client terminal, and to supply the pre-registered attribute data to the classifier as an additional input for generating the classification label.

3. The system according to claim 1, wherein the circuitry is further configured to, when the probability score is below the predetermined threshold, generate response data by applying a large language model using a retrieval-augmented generation architecture that searches a knowledge base for reference documents related to the classification label, and transmit the response data to the client terminal via the packet-switched network.

4. The system according to claim 1, wherein the circuitry is further configured to pre-process the image data by applying a super-resolution generative adversarial network model to restore detail in a low-resolution image, and to extract a segmentation mask and bounding box coordinates from the pre-processed image data using the convolutional neural network.

5. The system according to claim 1, wherein the multimodal input data further comprises video data, and the circuitry is further configured to extract key frames from the video data and generate spatiotemporal feature amounts from the key frames using a three-dimensional convolutional neural network.

6. The system according to claim 2, wherein the pre-registered attribute data comprises at least one of an age value, a gender category, and a vectorized embedding of historical records generated by a natural language processing model, and the circuitry is further configured to calculate a correction coefficient based on the pre-registered attribute data and apply the correction coefficient to the probability score.

7. The system according to claim 1, wherein the circuitry is further configured to estimate an emotion of a user of the client terminal by applying an emotion identification model to the audio data to generate an urgency score, and to dynamically adjust an interface configuration transmitted to the client terminal based on the urgency score.

8. The system according to claim 1, wherein the circuitry is further configured to analyze a history of past input data associated with a user of the client terminal and select an optimal input modality for the client terminal based on the history.

9. The system according to claim 1, wherein the circuitry is further configured to acquire environmental parameter data from sensors of the client terminal, the environmental parameter data comprising at least one of a current time, GPS coordinates, a noise level, and an illuminance value, classify a current environmental state based on the environmental parameter data, and adjust a user interface configuration transmitted to the client terminal based on the classified environmental state.

10. The system according to claim 1, wherein the circuitry is further configured to dynamically switch between a lightweight distilled model and a large-scale ensemble model for extracting the feature vector, based on an estimated emotion state of a user of the client terminal, such that the lightweight distilled model is selected when the estimated emotion state indicates urgency and the large-scale ensemble model is selected when the estimated emotion state indicates calmness.

11. The system according to claim 1, wherein the circuitry is further configured to apply a cascade processing pipeline comprising a first-stage lightweight model that generates a provisional importance score from the multimodal input data, and a second-stage high-precision model that performs detailed analysis only when the provisional importance score exceeds a predetermined importance threshold.

12. The system according to claim 1, wherein the circuitry is further configured to classify the multimodal input data into a category using a symptom classifier, and to select a specialized neural network model corresponding to the classified category from a plurality of specialized neural network models in a mixture-of-experts architecture.

13. The system according to claim 1, wherein the circuitry is further configured to calculate attention weights between a plurality of input tokens derived from the multimodal input data using a self-attention mechanism, and to generate a non-linear risk score based on interactions between the plurality of input tokens indicated by the attention weights.

14. The system according to claim 1, wherein the circuitry is further configured to retrieve attribute information of a submitter of the multimodal input data, encode the attribute information as a feature vector, concatenate the attribute information feature vector with the feature vector extracted from the multimodal input data, and input the concatenated vector to the classifier.

15. The system according to claim 1, wherein the circuitry is further configured to acquire geographic coordinates associated with the client terminal, retrieve an epidemic index corresponding to a geographic region containing the geographic coordinates, and adjust a prior probability used by the classifier based on the epidemic index.

16. The system according to claim 1, wherein the circuitry is further configured to perform a semantic search of a literature knowledge base using an embedding vector of the multimodal input data as a query, retrieve a reference document with a similarity score exceeding a literature threshold, and adjust the classification label based on the retrieved reference document.

17. The system according to claim 1, wherein the dispatch signal further comprises a data payload in a structured data format, the data payload including a summary of the classification label and the location data, and the circuitry is further configured to coordinate with the external system via an application programming interface to confirm receipt of the dispatch signal.

18. A system comprising:
circuitry configured to:
receive, via a communication interface coupled to a packet-switched network, multimodal input data from a client terminal, the multimodal input data comprising text data and image data;
tokenize the text data into a token sequence and embed the token sequence into a high-dimensional vector space using a Transformer-based encoder to generate a text embedding vector;
normalize pixel values of the image data to a predetermined range, resize the image data, and extract an image feature map from the normalized and resized image data using a convolutional neural network;
fuse the text embedding vector and the image feature map into a multidimensional tensor using a cross-attention mechanism that calculates a correlation between the text embedding vector and the image feature map;
generate a probability distribution over a plurality of classification categories by applying a classifier to the multidimensional tensor, and select a classification label corresponding to a highest probability in the probability distribution;
compare the highest probability against a predetermined threshold; and
in response to the highest probability exceeding the predetermined threshold, transmit a dispatch signal to an external system via the packet-switched network, the dispatch signal comprising GPS coordinates associated with the client terminal and a summary derived from the classification label.

19. The system according to claim 18, wherein the circuitry is further configured to, in response to the highest probability being below the predetermined threshold, search a knowledge base for reference documents related to the selected classification label using a retrieval-augmented generation architecture, input the reference documents and the multidimensional tensor into a large language model to generate a response text, and transmit the response text to the client terminal via the packet-switched network.

20. A method performed by circuitry of a system, the method comprising:
receiving, via a communication interface coupled to a packet-switched network, multimodal input data from a client terminal, the multimodal input data comprising at least one of text data, image data, and audio data;
extracting a feature vector from the multimodal input data by applying a neural network comprising a Transformer-based encoder for the text data and a convolutional neural network for the image data, and fusing outputs of the Transformer-based encoder and the convolutional neural network into a multidimensional tensor using a cross-attention mechanism;
generating a classification label and a probability score by applying a classifier to the multidimensional tensor; and
transmitting, via the packet-switched network, a dispatch signal to an external system when the probability score exceeds a predetermined threshold, the dispatch signal comprising location data associated with the client terminal.
